(19) United States
(12) Patent Application Publication
(10) Pub. No.: US 2014/0320775 A1
(43) Pub. Date: Oct. 30, 2014

(54) STEREOSCOPIC IMAGE DISPLAY DEVICE, METHOD FOR MANUFACTURING SAME, METHOD FOR REDUCING BOUNDARY VARIATION, STEREOSCOPIC IMAGE DISPLAY SYSTEM, AND PATTERNED PHASE DIFFERENCE PLATE

(71) Applicant: FUJIFILM Corporation, Tokyo (JP)

(72) Inventors: Makoto ISHIGURO, Kanagawa (JP); Takahiro OBA, Kanagawa (JP)

(73) Assignee: FUJIFILM CORPORATION, Tokyo (JP)

(21) Appl. No.: 14/331,641

(22) Filed: Jul. 15, 2014

Related U.S. Application Data
(63) Continuation of application No. PCT/JP2013/056627, filed on Mar. 11, 2013.

(30) Foreign Application Priority Data
Mar. 13, 2012 (JP) 2012-055215
Mar. 6, 2013 (JP) 2013-044062

(51) Int. Cl. G02B 27/26; G02B 5/30

(52) U.S. Cl. CPC G02B 27/26; G02B 5/3083
USPC 349/15; 445/24; 359/489.07

(57) ABSTRACT

A stereoscopic image display device including at least an image display panel and a patterned phase difference plate disposed on an image-displaying side of the panel, the patterned phase difference plate includes at least a supporter and a patterned optical anisotropic layer having, on the supporter, first phase difference regions and second phase difference regions which are different in either or both an in-plane slow axis direction and a phase difference, and are alternately disposed in a stripe shape, and, in the supporter, a linearity, which is a meandering width in a direction perpendicular to a direction along the pattern of the patterned optical anisotropic layer, of an edge in a direction along a pattern of the patterned optical anisotropic layer is 0.0195% or less of a length in the direction perpendicular to the direction along the pattern of the patterned optical anisotropic layer in the image display panel.

### CROSS-REFERENCE TO RELATED APPLICATIONS

This application is a Continuation of PCT International Application No. PCT/JP2013/056627 filed on Mar. 11, 2013, which claims priority under 35 U.S.C. §119(a) to Japanese Patent Application No. 2012-055215 filed Mar. 13, 2012, and Japanese Patent Application No. 2013-044062 filed Mar. 6, 2013, all of which are hereby expressly incorporated by reference into the present application.

### BACKGROUND OF THE INVENTION

1. Field of the Invention

The present invention relates to a stereoscopic image display device, a method for manufacturing the same, a method for reducing boundary variation, a stereoscopic image display system, and a patterned phase difference plate.

2. Description of the Related Art

In a stereoscopic (3D) image display device displaying a stereoscopic image, an optical member is required to turn an image for the right eye and an image for the left eye into, for example, circularly-polarized images in mutually opposite directions. For example, a patterned optical anisotropic element in which regions having mutually different slow axes, retardation and the like are regularly disposed in a plane is used as the aforementioned optical member, and a so-called film patterned retarder-type patterned phase difference film (FPR film) in which a film is used as a supporter for the patterned optical anisotropic element has been proposed.

As a method for manufacturing the FPR film, for example, a method in which a pattern is exposed in a state in which a support is not bent and, to improve the productivity, in a roll state is generally known, and, for example, a method in which a pattern is exposed in a state in which a certain degree of a tensile stress is applied to a supporter, or the like is known.

Meanwhile, in a stereoscopic image display device in which the FPR film is used, it is necessary to, for example, match pixels for an image for the right eye and an image for the left eye present in a display panel unit such as a liquid crystal panel to phase difference regions for an image for the right eye and an image for the left eye in the patterned optical anisotropic layer respectively. An FPR film having a patterned optical isotropic layer with a stripe pattern is generally used, and, when the FPR film is attached to a display panel, it is normal to coincide the cyclic direction of the pattern (a direction in which phase difference regions having mutually different stripe shapes are alternately switched) with the perpendicular direction (vertical direction) to the display surface. FIG. 4 schematically illustrates an example in which pixels for an image for the right eye and an image for the left eye in the display panel unit and the phase difference regions for an image for the right eye and an image for the left eye in the patterned optical anisotropic layer are disposed in accordance with each other. When the observation direction is in the normal direction to the display surface as illustrated using an arrow a in FIG. 4, light that has passed through the pixel for an image for the right eye (R) in the display panel passes through the phase difference region for an image for the right eye (R) in the patterned optical anisotropic layer, and therefore crosstalk does not occur. However, when the observation direction is changed from the normal direction to the display surface to the perpendicular direction to the display surface, as illustrated using an arrow b in FIG. 4, light that has passed through the pixel for an image for the right eye (R) in the display panel (for example, in a liquid crystal cell) passes through the phase difference region for an image for the left eye (L) in the patterned optical anisotropic layer, and therefore crosstalk occurs. That is, there is a problem in that the view angle of a stereoscopic image becomes narrow in the perpendicular direction of the display surface.

In order to solve the above-described problem, for example, in a space division-type stereoscopic liquid crystal display device in which the patterned optical anisotropic layer is used, the black matrix of a color filter disposed in a liquid crystal cell becomes large (H. Kang, S.-D. Roh, I.-S. Balk, H.-J. Jung, W.-N. Jeong, J.-K. Shin and I.-J. Chung, SID Symposium Digest 41, 1-4 (2010)).

### SUMMARY OF THE INVENTION

In the stereoscopic liquid crystal display device described in Kang et. al., while it is possible to reduce the above-described crosstalk, the size of the black matrix of the color filter is increased, and therefore it is necessary to revise the design of the entire liquid crystal cell, and there is a problem in that an existing liquid crystal cell cannot be used.

In addition, while the above-described crosstalk can be reduced, there is a problem of display variation caused by the patterned optical anisotropic layer, which is desired to be improved.

An object of the invention is to solve a variety of the above-described problems, and specifically, is to provide a stereoscopic image display device contributing to the reduction of the crosstalk view angle in the vertical direction and the reduction of 3D boundary variation, a method for manufacturing the same, a method for reducing boundary variation, a stereoscopic image display system, and a patterned phase difference plate.

When the FPR film is manufactured, it is normal to expose a pattern in a state in which a tensile stress is applied to a supporter.

That is, in the supporter before the exposure of the pattern, the edge of the supporter meanders in an extremely slight manner due to the influence of the arc, strain and the like of the supporter, and the edge of the supporter is not perfectly straight (“a” of FIG. 5). When a tensile stress is applied to the above-described supporter, the stress and the like in the edge of the supporter are alleviated, and the above-described meandering state is resolved. In addition, thus far, the pattern has been exposed in a state in which the strain and the like in the edge of the supporter are alleviated. That is, regions having mutually different slow axes, retardations and the like formed on the supporter are formed through the exposure of the pattern in a state in which the strain or meandering of the edge of the supporter is reduced (“b” of FIG. 5).

However, when a state in which the supporter is not included in the manufacturing line or a state in which the tensile stress applied to the supporter is removed due to the product form or the like is formed, the strain and the like in the edge of the supporter are developed again, and the edge of the supporter meanders. The above-described meandering of the edge of the supporter has remained at an extremely low level, and has not caused any problem in so-called two-dimensional (2D) display devices. However, as a result of studies, the present inventors found that the slight meandering has a great influence in a stereoscopic image display device. That is, the inventors found that, when the strain and the like of the edge of the supporter are developed again, the boundaries between the regions having mutually different slow axes, retardations and the like, which are formed on the supporter, also meander along the strain and the like in the edge of the supporter, and the performance of the stereoscopic image display device is significantly influenced; and completed the invention (“c” of FIG. 5). In addition, unexpectedly, it was found that, when the meandering of the edge of the supporter is alleviated, not only crosstalk but also 3D boundary variation can be improved.

Means for solving the above-described problems is means described in the following [1], and is preferably means described in the following [2] to [11].

[1] A stereoscopic image display device including at least an image display panel; and a patterned phase difference plate disposed on an image-displaying side of the image display panel,

in which the patterned phase difference plate includes at least a supporter and a patterned optical anisotropic layer having, on the supporter, first phase difference regions and second phase difference regions which are different in either or both an in-plane slow axis direction and a phase difference and are alternately disposed in a stripe shape, and

in which, in edges of the supporter, a linearity, which is a meandering width in a direction perpendicular to a direction along the pattern of the patterned optical anisotropic layer, of an edge in a direction along a pattern of the patterned optical anisotropic layer is 0.0195% or less of a length in the direction perpendicular to the direction along the pattern of the patterned optical anisotropic layer in the image display panel. Meanwhile, it is needless to say that the “patterned optical isotropic layer” is not limited thereto as long as the patterned optical isotropic layer includes the first phase difference regions and the second phase difference regions, and attention is paid to the fact that the patterned optical isotropic layer may further include other regions.

[2] The stereoscopic image display device according to [1] including a surface layer on a surface opposite to a surface on which the patterned optical anisotropic layer of the supporter is formed.

[3] The stereoscopic image display device according to [1] or [2], in which the linearity in the direction along the pattern of the patterned optical anisotropic layer is 0.0065% or less of a length in the direction perpendicular to the direction along the pattern of the image display panel.

[4] The stereoscopic image display device according to any one of [1] to [3], in which the supporter is any one of a cellulose acylate-based film, a polyester-based film, an acryl-based film and a norbornene-based film.

[5] The stereoscopic image display device according to any one of [1] to [4], in which the first and second phase difference regions have mutually orthogonal in-plane slow axes and have an in-plane retardation of λ/4.

[6] The stereoscopic image display device according to any one of [1] to [5], in which a size of the image display panel is in a range of 32 inches to 65 inches.

[7] The stereoscopic image display device according to any one of [1] to [6], in which the image display panel is a liquid crystal display panel.

[8] A method for manufacturing a stereoscopic image display device including at least an image display panel and a patterned phase difference plate disposed on an image-displaying side of the image display panel, in which the patterned phase difference plate includes at least a supporter and a patterned optical anisotropic layer having, on the supporter, first phase difference regions and second phase difference regions which are different in either or both an in-plane slow axis direction and a phase difference and are alternately disposed in a stripe shape, and

in which the patterned optical anisotropic layer is provided after, in edges of the supporter, a linearity, which is a meandering width in a direction perpendicular to a direction along the pattern of the patterned optical anisotropic layer, of an edge in a direction along a pattern of the patterned optical anisotropic layer is 0.0195% or less of a length in the direction perpendicular to the direction along the pattern of the patterned optical anisotropic layer in the image display panel.

[9] A method for reducing boundary variation in a stereoscopic image display device which includes at least an image display panel and a patterned phase difference plate disposed on an image-displaying side of the image display panel, and in which the patterned phase difference plate includes at least a supporter and a patterned optical anisotropic layer having, on the supporter, first phase difference regions and second phase difference regions which are different in either or both an in-plane slow axis direction and a phase difference and are alternately disposed in a stripe shape,

in which, as the supporter, a supporter having a linearity, which is a meandering width in a direction perpendicular to a direction along a pattern of the patterned optical anisotropic layer, in an edge in the direction along the pattern of the patterned optical anisotropic layer of 0.0195% or less of a length in the direction perpendicular to the direction along the pattern of the patterned optical anisotropic layer in the image display panel is used.

[10] A stereoscopic image display system including at least the stereoscopic image display device according to any one of [1] to [7]; and a polarization plate disposed on an image-displaying side of the stereoscopic image display device, in which a stereoscopic image is displayed through the polarization plate.

[11] A patterned phase difference plate including at least a supporter; and a patterned optical anisotropic layer having, on the supporter, first phase difference regions and second phase difference regions which are different in either or both an in-plane slow axis direction and a phase difference and are alternately disposed in a stripe shape,

in the supporter, a linearity, which is a meandering width in a direction perpendicular to a direction along the pattern of the patterned optical anisotropic layer, of an edge in a direction along a pattern of the patterned optical anisotropic layer is 0.0195% or less of a length in the direction perpendicular to the direction along the pattern of the patterned optical anisotropic layer.

According to the invention, it is possible to provide a stereoscopic image display device contributing to the reduction of the crosstalk view angle in the vertical direction and the reduction of 3D boundary variation, a method for manufacturing the same, a method for reducing boundary variation, a stereoscopic image display system, and a patterned phase difference plate.

### BRIEF DESCRIPTION OF THE DRAWINGS

FIG. 1 is a schematic cross-sectional view of an example of a stereoscopic image display device of the invention.

FIG. 2 is a schematic top view of an example of a patterned optical anisotropic layer.

FIGS. 3A and 3B are schematic views of an example of a relationship between a polarization film and an optical anisotropic layer.

FIG. 4 is a pattern diagram in which pixels for images for the right eye and images for the left eye in a display panel unit and phase difference regions for images for the right eye and images for the left eye in the patterned optical anisotropic layer are disposed in accordance with each other. Meanwhile, in FIG. 4, X indicates that “pixels for the right eye among the pixels in a liquid crystal cell and pixels for the right eye in an FPR film match each other”, and Y indicates that “pixels for the right eye among the pixels in a liquid crystal cell and pixels for the right eye in an FPR film do not match each other”.

FIG. 5 is a schematic view illustrating relationship between the production of FPR films and the strain or meandering of supporters. Meanwhile, a in “a” of FIG. 5 indicates that “a supporter edge meanders due to a base arc, strain (including earing and the like) and the like”, β in “b” of FIG. 5 indicates “a state in which a tensile stress is applied to a supporter, the meandering of the supporter edge is reduced”, and γ in “c” of FIG. 5 indicates that “when the tensile stress is removed, the supporter edge meanders, and accordingly, a pattern also meanders”.

FIGS. 6A and 6B are schematic views illustrating examples of exposure masks.

### DESCRIPTION OF THE PREFERRED EMBODIMENTS

Hereinafter, the invention will be described in detail. Meanwhile, in the present specification, numeric ranges expressed using “to” indicate that the range includes numeric values described before and after “to” as the lower limit value and the upper limit value. First, terminologies used in the specification will be described.

Re (λ) and Rth (λ) represent in-plane retardation and retardation in the thickness direction at a wavelength of λ respectively. Re (λ) is measured by entering light having a wavelength of λ nm in a film normal direction in a KOBRA 21ADH or WR (manufactured by Oji Scientific Instruments). When a measurement wavelength λ nm is selected, Re (λ) can be measured by manually exchanging wavelength-selecting filters or by converting a measured value using a program or the like. In a case in which a film under measurement is a film expressed as a uniaxial or biaxial index ellipsoid, Rth (λ) can be computed using the following method. Meanwhile, a part of the measurement method is also used to measure the average tilt angle of discotic liquid crystal molecules in an orientation film side section in an optical anisotropic layer described below and the average tilt angle in the opposite side section.

Rth (λ) can be computed as described below: the in-plane slow axis (determined by a KOBRA 21ADH or WR) is used as an inclined axis (rotation axis) (in a case in which there is no slow axis, an arbitrary direction in a film plane is used as the rotation axis), the Re (λ) is measured at a total of six points using light having a wavelength of λ nm being incident in a film normal direction and five other directions inclined from the normal direction toward a single side at ten-degree angular intervals up to 50 degrees, and a KOBRA 21ADH or WR computes Rth (λ) based on the measured retardation values, the assumed value of the average refractive index, and the input film thickness value. During the above-described computation, in a case in which a film has a direction in which the retardation value becomes zero at a certain inclined angle when the in-plane slow axis in the normal direction is used as the rotation axis, Rth (λ) is computed by a KOBRA 21ADH or WR after retardation values at inclined angles larger than the above-described inclined angle are changed to negative values. Meanwhile, it is also possible to use the slow axis as the inclined axis (rotation axis) (in a case in which there is no slow axis, an arbitrary direction in a film plane is used as the rotation axis), measure retardation values in two arbitrary inclined directions, and compute Rth using the following formulae (A) and (B) based on the measured retardation values, the assumed value of the average refractive index, and the input film thickness value.

$$Formula ( A )$$

$$Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}}$$

Here, the Re (θ) represents a retardation value in a direction inclined from the normal direction by an angle of θ. In addition, nx in Formula (A) represents the refractive index in an in-plane slow axis direction, ny represents the refractive index in a direction orthogonal to nx in a plane, and nz represents the refractive index in a direction orthogonal to nx and ny. d represents the film thickness.

Rth=((nx+ny)/2−nz)×d Formula (B)

In a case in which the film under measurement is an article that cannot be expressed as a uniaxial or biaxial index ellipsoid, that is, a film having no optical axis, Rth (λ) is computed using the following method: the in-plane slow axis (determined by a KOBRA 21ADH or WR) is used as an inclined axis (rotation axis), the Re (λ) is measured at eleven points using light having a wavelength of λ nm being incident in directions inclined from −50 degrees to +50 degrees with respect to the film normal direction at ten-degree angular intervals, and a KOBRA 21ADH or WR computes Rth (λ) based on the measured retardation values, the assumed value of the average refractive index, and the input film thickness value. During the above-described measurement, values from a polymer handbook (JOHN WILEY & SONS, INC.) and a variety of optical film catalogues can be used as the assumed value of the average refractive index. Regarding an average refractive index that has not been known, it is possible to measure the average refractive index using an Abbe refractometer. The average refractive indexes of principal optical films are as described below: cellulose acylate (1.48), cycloolefin polymer (1.52), polycarbonate (1.59), polymethyl methacrylate (1.49) and polystyrene (1.59). The KOBRA 21ADH or WR computes nx, ny and nz when the assumed value of the average refractive index and the film thickness are input. Nz=(nx−nz)/(nx−ny) is further computed using the above-computed nx, ny and nz.

Meanwhile, in the specification, “visible light” has a wavelength in a range of 380 nm to 780 nm. In addition, in the specification, in a case in which there is no particular description regarding the measurement wavelength, the wavelength is 550 nm.

In addition, in the specification, angles (for example, angles of “90°” and the like) and the angular relationships (for example, “orthogonal”, “parallel”, “intersecting at 45°” and the like) include the error range accepted in the technical field to which the invention belongs. For example, an angle means an angle in a range of less than ±10° of the rigorous angle, and the error from the rigorous angle is preferably 5° or less, and more preferably 3° or less.

A patterned phase difference plate of the invention includes at least a supporter and a patterned optical anisotropic layer having, on the supporter, first phase difference regions and second phase difference regions which are different in either or both an in-plane slow axis direction and a phase difference and are alternately disposed in a stripe shape,

in which, in the supporter, a linearity, which is a meandering width in a direction perpendicular to a direction along the pattern of the patterned optical anisotropic layer, of an edge in a direction along a pattern of the patterned optical anisotropic layer is 0.0195% or less of a length in the direction perpendicular to the direction along the pattern of the patterned optical anisotropic layer.

In addition, a stereoscopic image display device of the invention is a stereoscopic image display device including at least an image display panel, and the patterned phase difference plate disposed on an image-displaying side of the image display panel, in which the patterned phase difference plate includes at least a supporter and a patterned optical anisotropic layer having, on the supporter, first phase difference regions and second phase difference regions which are different in either or both an in-plane slow axis direction and a phase difference and are alternately disposed in a stripe shape, in edges of the supporter, a linearity, which is a meandering width in a direction perpendicular to a direction along the pattern of the patterned optical anisotropic layer, of an edge in a direction along a pattern of the patterned optical anisotropic layer is 0.0195% or less of a length in the direction perpendicular to the direction along the pattern of the patterned optical anisotropic layer in the image display panel.

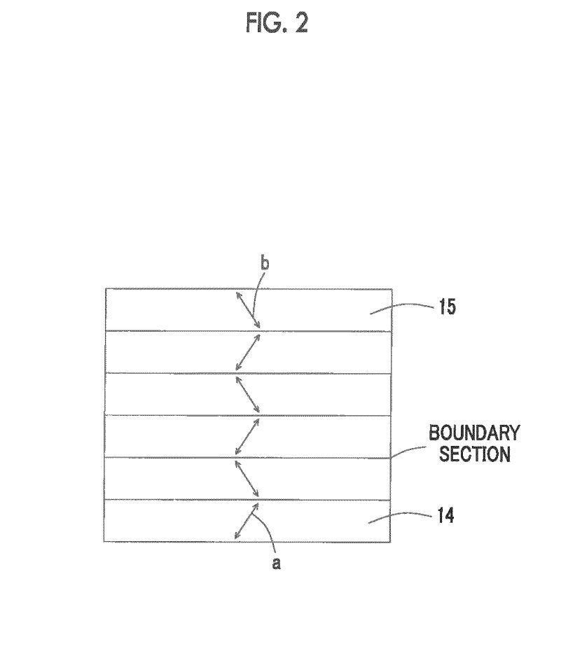

In the invention, when the linearity of the edge in the direction along the pattern of the supporter of the patterned phase difference plate is set to 0.0195% or less of the length in the direction perpendicular to the direction along the pattern of the patterned optical anisotropic layer, even when a state in which the supporter is not under the application of a tensile stress is formed, the re-development of the strain or meandering of the supporter is suppressed. In the related art, it was possible to reduce the crosstalk view angle in the vertical direction, but it was not possible to reduce 3D boundary variation. However, it was found that, when the linearity is set to the above-described value, it is possible to reduce not only the crosstalk view angle in the vertical direction but also 3D boundary variation. Meanwhile, the direction along the pattern refers to a direction in parallel with the stripe-shaped pattern. For example, as exemplified in FIG. 2, the direction along the pattern refers to a direction along the boundary portion between the first and second phase difference regions that are alternately disposed in a stripe shape.

The inventors consider to be as follows the reasons for the invention capable of solving the problems of not only the crosstalk view angle in the vertical direction but also 3D boundary variation.

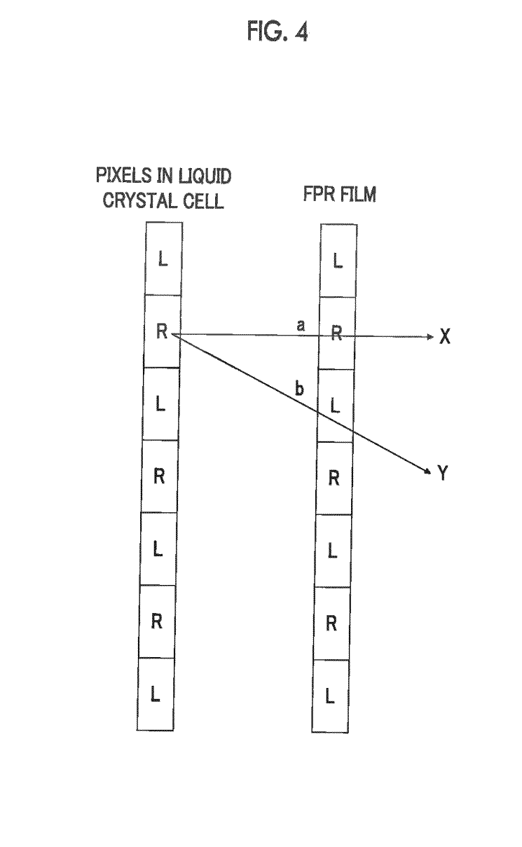

As illustrated in FIG. 4, the narrowness of the crosstalk view angle in the vertical direction results from the misalignment between pixels in a liquid crystal cell and the patterned optical anisotropic layer. Therefore, when an FPR film in a state in which the strain or meandering of the supporter is developed again is used, the variation of the misalignment with the pixels in the liquid crystal cell in the image display region is large, and therefore the misalignment with the pixels in the liquid crystal cell becomes great throughout the entire image display region. However, when the meandering and the like of the FPR film are small, the variation of the misalignment with the pixels in the liquid crystal cell in the image display region also becomes small, and consequently, the misalignment with the pixels in the liquid crystal cell in consideration of the entire image display region becomes narrow, and therefore it is considered that the crosstalk view angle in the vertical direction becomes great.

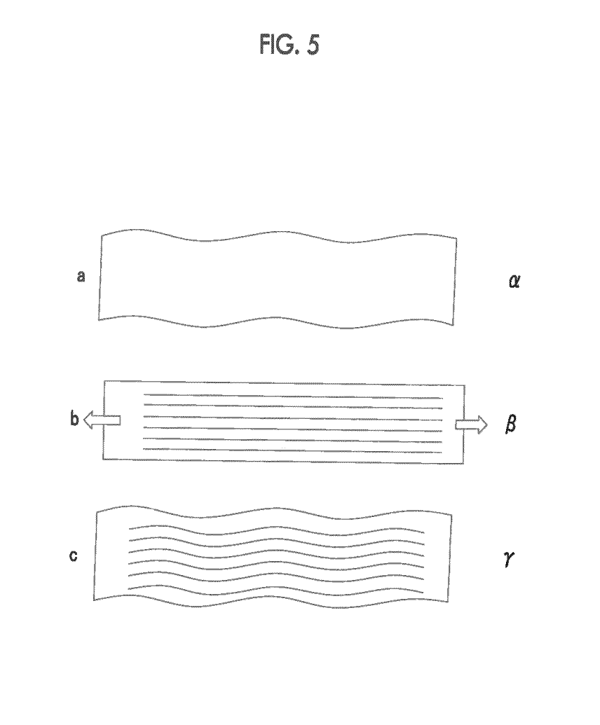

In addition, when the meandering and the like of the edge of the supporter are great, the boundary between the first phase difference region and the second phase difference region also meanders (“c” of FIG. 5). When observed in the vertical direction, the meandering is observed as the variation of 3D display (3D boundary variation), and the quality of the 3D display deteriorates. On the other hand, when the meandering and the like of the FPR film are reduced, the 3D boundary variation becomes unobservable so that the stereoscopic effect of a 3D image in a screen can be strengthened, and it is considered that the problem of the 3D boundary variation can also be solved.

Hereinafter, an embodiment of the invention will be described with reference to the drawings, and the correlations between the thicknesses of individual layers in the drawings do not reflect the actual correlations. In addition, in the drawings, similar members are given similar reference signs, and in some cases, will not be described in detail.

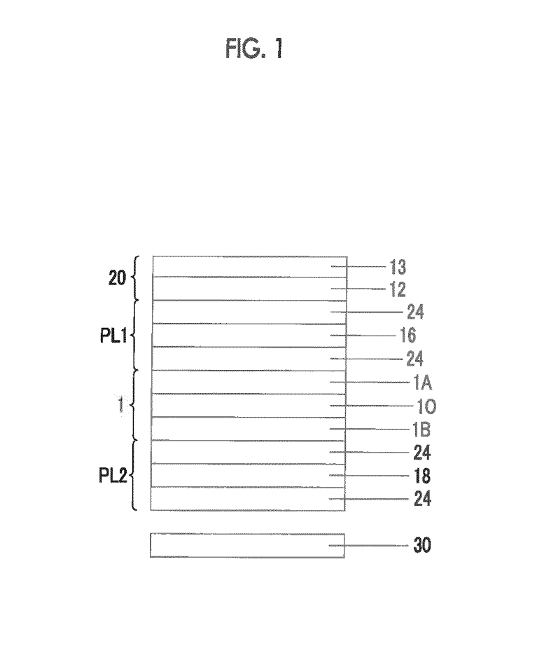

A schematic cross-sectional view of an example of the stereoscopic image display device of the invention is illustrated in FIG. 1. The stereoscopic image display device includes a pair of an image-displaying side polarization film 16 and a backlight side polarization film 18, an image display panel 1 disposed therebetween, and a patterned phase difference plate 20, and is provided with a backlight 30 further outside the backlight side polarization film 18. The patterned phase difference plate 20 is disposed on an image-displaying side surface of the image display panel, and separates polarization images into polarization images for the right eye and polarization images for the left eye (for example, circularly-polarized images). An observer observes the polarized images through a polarization plate such as polarized glasses (for example, circularly-polarized glasses), and recognizes as stereoscopic images.

The polarization film 16 and the polarization film 18 have protective films 24 on both surfaces respectively. Meanwhile, the image-displaying side polarization film 16 may be incorporated as a polarization plate PL1 having the protective films 24 attached to individual surfaces respectively. The backlight side polarization film 18 may also be incorporated as a polarization plate PL2 having the protective films 24 attached to individual surfaces respectively.

Meanwhile, FIG. 1 is a schematic cross-sectional view of an example of a case in which the image display panel is a liquid crystal panel, but there is not any limitation with the image display panel 1. For example, the image display panel may be an organic EL display panel including an organic EL layer or a plasma display panel.

In a case in which the image display panel 1 is a liquid crystal panel, a liquid crystal cell includes a pair of substrates 1A and 1B and a liquid crystal layer 10 which is disposed therebetween and includes a nematic liquid crystal material. Rubbing orientation films (not illustrated) are disposed on the inside surfaces of the substrates 1A and 1B, and the orientations of the nematic liquid crystals are controlled using individual rubbing directions so as to be twisted. In addition, electrode layers (not illustrated) are formed on the inside surfaces of the substrates 1A and 1B, and, when a voltage is applied, the twisted orientation of the nematic liquid crystal is nullified, and the nematic liquid crystals are oriented perpendicularly to the substrate surface. The liquid crystal cell LC may include other members such as a color filter and the like.

There is no particular limitation with the configuration of the liquid crystal cell, and it is possible to employ a liquid crystal cell with an ordinary configuration. Also, there is no particular limitation with the driving mode of the liquid crystal cell, and it is possible to use a variety of modes such as twisted nematic (TN), super twisted nematic (STN), vertical alignment (VA), in-plane switching (IPS) and optically compensated band cell (OCB).

There is no particular limitation with the size of the image display panel, but the size is preferably in a range of 32 inches to 65 inches (approximately 80 cm to approximately 165 cm). According to the invention, since the view angle of a stereoscopic image becomes wider than the related art, in a case in which the image display panel is applied to a middle-sized to large-sized image display panel in a range of 32 inches to 65 inches rather than a small-sized image display panel, a stereoscopic image becomes easily observable, and the image display panel tends to particularly exhibit the effect.

The patterned phase difference plate 20 is a so-called FPR film, and as illustrated in FIGS. 1 and 2, the patterned phase difference plate includes a patterned optical anisotropic layer 12 having first phase difference regions 14 and second phase difference regions 15 on a supporter 13, and includes a boundary portion between the first and second phase difference regions. Meanwhile, a (light) orientation film that is ordinarily used to control the orientation of the optical anisotropic layer will not be described.

The linearity of the edge of the supporter refers to, in the edges of the supporter, the meandering width of the edge in a direction along the pattern of the patterned optical anisotropic layer supporter (hereinafter, also referred to as “horizontal direction” (longitudinal direction)) in a direction perpendicular to the direction along the pattern of the patterned optical anisotropic layer. In addition, the linearity of the edge of the supporter is the width (the length of the perpendicular line) which is in parallel with the horizontal direction of the image display panel, and meanders in a direction perpendicular to a straight line combining both edges of the supporter (hereinafter, also referred to as “vertical direction”). The linearity of the edge of the supporter is preferably 0.0195% or less of the length in the direction perpendicular to the direction along the pattern of the patterned optical anisotropic layer in the image display panel.

Meanwhile, the “direction along the pattern” mentioned herein is a direction along the pattern of the patterned optical anisotropic layer, and refers to a direction along the longitudinal direction of the stripe-shaped phase difference regions. In addition, the “edge in a direction along the pattern of the patterned optical anisotropic layer” of the supporter refers to the edge of the supporter which is the edge present in a direction perpendicular to the direction along the pattern of the patterned optical anisotropic layer.

The employment of the above-described configuration enables the reduction of the crosstalk in the vertical direction and 3D boundary variation.

Specifically, for example, when the length of the image display device in the vertical direction is set to 390 mm, the difference between the length of the above-described perpendicular line and the length of the image display panel in the vertical direction is preferably 75 μm or less, and more preferably 50 μm or less.

The length of the perpendicular line of the supporter is measured as described below.

1) In a roll-shaped supporter, a point A at one edge and a point B at the other edge of the length range of the image display panel in the horizontal direction are provided, and a straight line combining A and B is drawn. Meanwhile, the straight line between A and B is set to be in parallel with the horizontal direction of the image display panel.

2) A line perpendicular to the straight line combining A and B is drawn.

3) 1) and 2) are carried out at 10 positions in the longitudinal direction of the roll-shaped supporter at intervals of 3 m, and the ratio of the length of a perpendicular line of the supporter is defined as a so-called linearity of the edge of the supporter when the longest perpendicular line is considered as the “length of the perpendicular line of the supporter”, and the length of the image display panel in the vertical direction is considered as the criterion.

The patterned optical anisotropic layer 12 can be formed of one curable composition or multiple curable compositions mainly containing a liquid crystal compound, and the liquid crystal compound is preferably a liquid crystal compound having a polymerizable group. The liquid crystal compound is preferably a liquid crystal compound formed of one curable composition described above. The patterned optical anisotropic layer 12 may have a single layer structure or a laminate structure of two or more layers. The patterned optical anisotropic layer can be formed of one or two compositions mainly containing the liquid crystal compound.

The linearity of the patterned optical anisotropic layer is preferably 0.0065% or less, and more preferably 0.0025% or less of the length of the image display panel in the vertical direction. Then, it is possible to reduce the crosstalk in the vertical direction and 3D boundary variation.

Here, the linearity of the patterned optical anisotropic layer refers to the ratio of the length of the line perpendicular to the straight line combining points 40 mm away from both edges of the boundary portion when the length of the image display panel in the vertical direction is used as the criterion.

The perpendicular direction of the patterned optical anisotropic layer is measured as described below.

1) A point A 40 mm away from the initial point of an arbitrary boundary portion and a point B 40 mm away from the terminal point of the boundary portion are provided, and a straight line combining A and B is drawn.

2) A line perpendicular to the straight line combining A and B which passes through the point A, a line perpendicular to the straight line combining A and B which passes through the point B, and a line perpendicular to the straight line combining A and B which passes through the center of the straight line are drawn, and the lengths of the three lines are measured.

3) 1) and 2) are carried out on 20 FPR films, and the ratio of the length of a perpendicular line of the patterned optical anisotropic layer is defined as a so-called linearity of the patterned optical anisotropic layer when the longest perpendicular line is considered as the “length of the perpendicular line of the patterned optical anisotropic layer”, and the length of the image display panel in the horizontal direction is considered as the criterion.

As illustrated in FIG. λ an example of the patterned optical anisotropic layer 12 is a patterned λ/4 layer in which in-plane slow axes a and b in the first and second phase difference regions 14 and 15 are orthogonal to each other and the in-plane retardation Re is λ/4. When this aspect of patterned optical anisotropic layer is combined with a polarization film, light rays that have passed through the first and second phase difference regions respectively turn into mutually-reversed circularly-polarized states, and form circularly-polarized images for the right eye and the left eye respectively.

The patterned λ/4 layer can be formed by, for example, uniformly forming an orientation film on a surface of the supporter 13, carrying out an orientation treatment in a direction, orientating the liquid crystal curable composition on an orientation-treated surface, and fixing the liquid crystal curable composition in the oriented state. In one of the first and second phase difference regions 14 and 15, liquid crystals are oriented orthogonally or perpendicularly to an orientation restriction treatment direction (for example, a rubbing direction), that is, orthogonally or perpendicularly oriented, in the other region, liquid crystals are oriented in parallel with or perpendicularly to the orientation restriction treatment direction (for example, a rubbing direction), that is, oriented in parallel or perpendicularly, and the liquid crystals are fixed in the oriented states, whereby the respective phase difference regions can be formed.

The patterned phase difference plate is useful as a member for a stereoscopic image display device, particularly for a passive-type stereoscopic image display device. In this aspect, polarized images that have passed through the first and second phase difference regions respectively are recognized as images for the right eye and the left eye through polarization glasses or the like. Therefore, the first and second phase difference regions preferably have mutually equal shapes so as to prevent right and left images from becoming non-uniform, and the first and second phase difference regions are preferably disposed in equal and symmetric patterns respectively.

In the invention, the patterned optical anisotropic layer is not limited to the aspect illustrated in FIG. 2. It is possible to use display pixel regions in which the in-plane retardation is λ/4 in one of the first and second phase difference regions and the in-plane retardation is 3λ/4 in the other region. Furthermore, it is also possible to use first and second phase difference regions 14 and 15 in which the in-plane retardation is λ/2 in one of the regions and the in-plane retardation is 0 in the other region.

In addition, the in-plane slow axes of individual patterns in the first and second phase difference regions can be adjusted to be in mutually different directions, for example, in mutually orthogonal directions using patterned orientation films or the like. As the patterned orientation film, it is possible to use any of a photo-orientation film that is capable of forming a patterning orientation film through mask exposure, a rubbing orientation film that is capable of forming a patterning orientation film through mask rubbing, and an orientation film in which different types of orientation films (for example, a material oriented orthogonally or in parallel with rubbing) are pattern-disposed through printing or the like. Meanwhile, in a case in which the respective in-plane slow axes in the first and second phase difference regions are mutually orthogonal, the in-plane slow axis in a boundary section preferably has an approximately intermediate value between the in-plane slow axis directions of the first and second phase difference regions, that is, approximately 45 degrees.

The patterned phase difference plate is not limited to the aspect simply illustrated in FIGS. 1 and 2, and may include other members. For example, in an aspect in which the patterned optical anisotropic layer is formed using an orientation film as described above, the orientation film may be provided between the supporter and the patterned optical anisotropic layer. In addition, the patterned phase difference plate in the invention may have a surface layer such as a forward scattering layer, a primer layer, an antistatic layer or a basecoat layer disposed on the supporter film together with a bar coated layer, an antireflection layer, a low reflection layer, an antiglare layer or the like (or in exchange of the above-described layers) on a surface opposite to a surface on which the patterned optical anisotropic layer of the supporter is formed.

The polarization films 16 and 18 are disposed so that individual transmission axes are orthogonal to each other. In an example, the transmission line of the polarization film 16 is in parallel with the rubbing axis of the substrate 1A, and the transmission axis of the polarization film 18 is in parallel with the rubbing axis of the substrate 1B.

Ordinary linear polarization plates can be used as the polarization films 16 and 18. The polarization films may be made of a stretched film or may be layers formed through coating. The former example includes a film obtained by dying a stretched film of polyvinyl alcohol using iodine, a dichromatic dye, or the like. The latter example includes a layer fixed in a predetermined orientation state by applying a composition containing a dichromatic pigment.

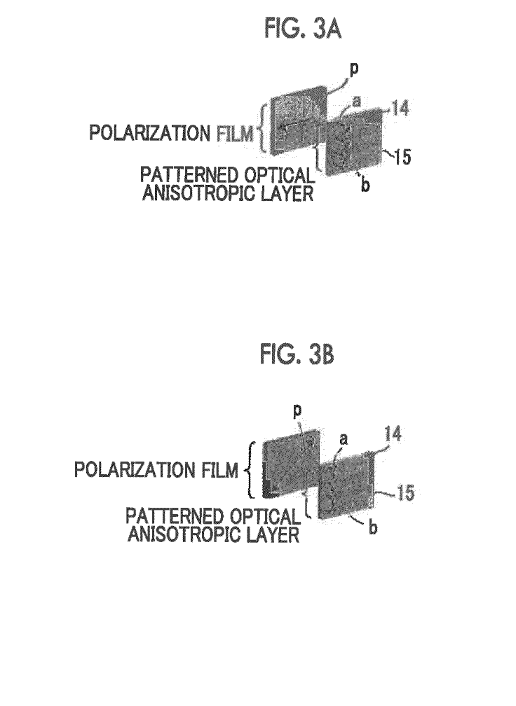

As illustrated in an example in FIGS. 3A and 3B, the polarization film 16 has the in-plane slow axes a and b in the first and second phase difference regions 14 and 15 respectively disposed at ±45° with respect to a transmission axis p of the polarization film. In the specification, the angle is not required to be strictly ±45°, and the in-plane slow axis is preferably disposed at an angle in a range of 40° to 50° in any one of the first and second phase difference regions 14 and 15, and is preferably disposed at an angle in a range of −50° to −40° in the other region. With the above-described configuration, circularly-polarized images for the right eye and the left eye can be separated. In addition, when a λ/2 plate is further laminated, the view angle may be further widened.

It is preferable to dispose no additional layer or only an optically isotropic layer (for example, an adhesive layer) between the patterned optical anisotropic layer 12 and the polarization film 16.

The protective films 24 are disposed on both surfaces of the polarization film 16 and the polarization film 18. There is no particular limitation with the protective film 24, a variety of polymer films can be used, and the protective film may be a film containing a cellulose acylate-based film, an acryl-based polymer or a cyclic olefin resin, which is generally used as the protective film of the polarization plate, as a main component. In addition, instead of the protective film 24, a phase difference film for view angle compensation may be disposed, or may not be disposed. The in-plane slow axes of the phase difference film are preferably disposed in parallel with or orthogonally to the direction of rubbing carried out on the inside surfaces of the substrates 1A and 1B, and are more preferably disposed in parallel. The phase difference film may be an optically biaxial film or a film made up of the supporter and an optical anisotropic layer obtained by curing a rod-shaped or discotic liquid crystal compound.

The invention also relates to a stereoscopic image display system which includes at least the stereoscopic image display device of the invention and the polarization plate disposed on the image-displaying side of the stereoscopic image display device, and displays a stereoscopic image through the polarization plate. An example of the polarization plate disposed on the image-displaying side of the stereoscopic image display device is polarized glasses worn by an observer. The observer observes a polarized image for the right eye and a polarized image for the left eye displayed by the stereoscopic image display device through circularly or linearly polarized glasses, and recognizes the images as stereoscopic images.

The invention also relates to a method for manufacturing a stereoscopic image display device including the providing of the patterned optical anisotropic layer after the linearity of the edge of the supporter in the patterned optical anisotropic layer in a direction along the pattern is set to 0.0195% or less of the length in the direction perpendicular to the direction along the pattern of the image display panel. When the patterned optical anisotropic layer is provided after the linearity of the edge of the supporter is set to 0.0195% or less of the length in the direction perpendicular to the direction along the pattern of the image display panel, it is also possible to increase the linearity of the patterned optical anisotropic layer. Then, it is possible to reduce the crosstalk view angle in the vertical direction and 3D boundary variation.

The invention also relates to a method for reducing the boundary variation of a stereoscopic image display device in which a supporter having a linearity in the edge in the direction along the pattern of the supporter of 0.0195% or less of the length in the direction perpendicular to the direction along the pattern of the image display panel is used as the supporter of the patterned optical anisotropic layer. When a supporter having a linearity of 0.0195% or less of the length in the direction perpendicular to the direction along the pattern of the image display panel is used, it is possible to reduce not only the crosstalk view angle in the vertical direction but also 3D boundary variation.

Hereinafter, a variety of members and the like in which the patterned phase difference plate of the invention is used will be described in detail.

Patterned Optical Anisotropic Layer:

In the invention, the patterned optical anisotropic layer includes a first phase difference region and a second phase difference region having mutually different in-plane slow axis directions and/or in-plane retardation, the first and second phase difference regions are alternately disposed in a plane, and includes a boundary section between the first phase difference region and the second phase difference region. An example of the patterned optical anisotropic layer is an optical anisotropic layer in which the first and second phase difference regions have Re of approximately λ/4 respectively, and the in-plane slow axes are orthogonal to each other. There are a variety of methods for forming the above-described patterned optical anisotropic layer; however, in the invention, the patterned optical anisotropic layer is preferably formed by polymerizing and fixing a rod-shaped liquid crystal having a polarizable group in a state of being horizontally oriented and a discotic liquid crystal in a state of being vertically oriented.

The sole patterned optical anisotropic layer may have Re of approximately λ/4, and in this case, Re (550) is preferably approximately λ/4±30 nm, more preferably in a range of 110 nm to 165 nm, still more preferably in a range of 120 nm to 150 nm, and particularly preferably in a range of 125 nm to 145 nm. Meanwhile, in the specification, the in-plane retardation Re of λ/4 refers to a value having a width in a range of ¼ of the wavelength λ±approximately 30 nm unless particularly otherwise described, and the in-plane retardation Re of λ/2 refers to a value having a width in a range of ½ of the wavelength λ±approximately 30 nm unless particularly otherwise described. In addition, a majority of commercially available supporters have a positive Rth. In a case in which the patterned optical anisotropic layer is formed on a supporter having a positive Rth, the Rth (550) of the patterned optical anisotropic layer is preferably a negative value, is preferably in a range of −80 nm to −50 nm, and more preferably in a range of −75 nm to −60 nm

Generally, the liquid crystal compounds can be classified into a rod shape type and a discotic type depending on their shapes. Furthermore, the rod-shaped liquid crystal compound and the discotic liquid crystal compound respectively have a low molecule type and a high molecule type. The high molecule generally refers to a molecule having a degree of polarization of 100 or more (Polymer Physics and Phase Transition Dynamics by Masao Doi, page 2, Iwanami Shoten, Publishers, 1992). In the invention, any liquid crystal compound can be used, but the rod-shaped liquid crystal compound and the discotic liquid crystal compound are preferably used. Two or more rod-shaped liquid crystal compounds, two or more discotic liquid crystal compound, or a mixture of the rod-shaped liquid crystal compound and the discotic liquid crystal compound may be used. Since the temperature change or the humidity change can be decreased, the patterned optical anisotropic layer is more preferably formed using the rod-shaped liquid crystal compound and the discotic liquid crystal compound having a reactive group, and it is more preferable that at least a single liquid crystal molecule have two or more reactive groups. The liquid crystal compound may be a mixture of two or more liquid crystal compounds, and in this case, at least a single liquid crystal compound preferably has two or more reactive groups.

As the rod-shaped liquid crystal compound, for example, the liquid crystal compounds described in JP1999-513019A (JP-H11-513019A) or JP2007-279688A can be used, and as the discotic liquid crystal compound, for example, the liquid crystal compounds described in JP2007-108732A or JP2010-244038A can be preferably used, but the liquid crystal compounds are not limited thereto.

The liquid crystal compound also preferably has two or more reactive groups having different polymerization conditions. In this case, it becomes possible to produce a phase difference layer including a high molecule with an unreacted reactive group by selecting conditions and polymerizing only part of a plurality of reactive groups. The polymerization conditions being used may be a wavelength range of ionizing radiation used for polymerization fixing, may be a difference in the polymerization mechanism being used, and preferably, may be a combination of a radical reactive group and a cationic reactive group that can be controlled using the type of an initiator being used. A combination in which the radical reactive group is an acryl group and/or a methacryl group and the cationic group is a vinyl ether group, an oxetane group and/or an epoxy group is particularly preferred since the reactivity is easy to control.

The optical anisotropic layer can be formed using a variety of methods in which an orientation film is used, and there is no particular limitation with the manufacturing method.

A first aspect is a method in which a plurality of actions having an effect on the control of the orientation of liquid crystals is used, and then a part of the actions is lost using an external stimulus (thermal treatment or the like), thereby making a predetermined orientation control action dominant. For example, liquid crystals are put into a predetermined orientation state using the combined actions of the orientation control performance by an orientation film and the orientation control performance of an orientation control agent added to the liquid crystal compound, the liquid crystals are fixed so as to form a phase difference region, then, a part of the actions (for example, the action by the orientation control agent) is lost using an external stimulus (thermal treatment or the like) so as to make the other orientation control action (the action by the orientation film) dominant, thereby realizing another orientation state, and the orientation state is fixed so as to form another phase difference region. For example, in a predetermined pyridinium compound or imidazolium compound, a pyridinium group or an imidalium group is hydrophilic, and is thus eccentrically present on the surface of a hydrophilic polyvinyl alcohol orientation film. Particularly, when the pyridinium group, furthermore, an amino group that is a substitute of an acceptor of a hydrogen atom is substituted, an intermolecular hydrogen bond is generated between the amino group and polyvinyl alcohol, the amino group is eccentrically present on the surface of the orientation film at a higher density, and a pyridinium derivative is oriented in a direction orthogonal to the main chain of polyvinyl alcohol due to the effect of the hydrogen bond, and therefore the orthogonal orientation of liquid crystals is promoted in a rubbing direction. Since the pyridinium derivative has a plurality of aromatic rings in the molecule, a strong intermolecular π-π interaction is caused between the pyridinium derivative and the above-described liquid crystal, particularly, the discotic liquid crystal compound, and orthogonal orientation is caused in the vicinity of the interface of the orientation film with the discotic liquid crystal. Particularly, when a hydrophobic aromatic ring is coupled with the hydrophilic pyridinium group, there is another effect that vertical orientation is caused by the effect of the hydrophobicity. However, when the pyridinium derivative is heated so as to be hotter than a certain temperature, the hydrogen bond is broken, the density of the pyridinium compound and the like on the surface of the orientation film decreases, and the action is lost. As a result, the liquid crystals are oriented by the restraining force of the rubbing orientation film, and the liquid crystals turn into a parallel orientation state. The details of the above-described method are described in the specification of JP2010-141346A (JP2012-8170A), and the content thereof is incorporated in the specification for reference.

A second aspect is an aspect in which a patterned orientation film is used. In this aspect, a patterned orientation film having mutually different orientation control performances is formed, a liquid crystal compound is disposed on the patterned orientation film, and liquid crystals are oriented. The liquid crystals are controlled to be oriented by the respective orientation control performances of the patterned orientation film, thereby achieving mutually different orientation states. Patterns of the first and second phase difference regions are formed in accordance with the patterns of the orientation film by fixing the respective orientation states. The patterned orientation film can be formed using a printing method, mask rubbing against the rubbing orientation film, mask exposure against an optical orientation film, or the like. In addition, the patterned orientation film can be also formed by uniformly forming the orientation film, and separately printing additives (for example, the above-described onium salt or the like) having an effect on the orientation control performance in a predetermined pattern. A method in which the printing method is used is preferred since a large-scale facility is not required and the manufacturing is simple. The details of the above-described method are described in the specification of JP2010-173077A (JP2012-032661A), and the content thereof is incorporated in the specification for reference.

In addition, the first and second aspects may be jointly used. An example is the addition of a photo-acid-generating agent to the orientation film. In this example, a photo-acid-generating agent is added to the orientation film, and the photo-acid-generating agent is decomposed by pattern exposure, thereby forming a region in which an acidic compound is generated and a region in which an acidic compound is not generated. In a portion not irradiated with light, the photo-acid-generating agent is rarely decomposed, the interaction among the orientation film material, liquid crystals and the orientation control agent added as desired has a dominant effect on the orientation state, and the liquid crystals are oriented so that the slow axes are orthogonal to the rubbing direction. When light is radiated to the orientation film, and an acidic compound is generated, the interaction is no longer dominant, the rubbing direction of the rubbing orientation film has a dominant effect on the orientation state, and the liquid crystals are oriented in parallel with the slow axes being in parallel with the rubbing direction. A water-soluble compound is preferably used as the photo-acid-generating agent used for the orientation film. Examples of an available photo-acid-generating agent include the compounds described in Prog. Polym. Sci., Vol. 23, page 1485 (1998). As the photo-acid-generating agent, pyridinium salt, idonium salt and sulfonium salt are particularly preferably used. The details of the above-described method are described in the specification of JP2010-289360A (JP2012-150428A which is based on the specification of JP2010-289360A), and the content thereof is incorporated in the specification for reference.

Furthermore, as a third aspect, there is a method in which a discotic liquid crystal compound having polymerizable groups (for example, an oxetanyl group and a polymerizable ethylenic unsaturated group) with mutually different polymerization properties is used. In this aspect, the discotic liquid crystal compound is put into a predetermined orientation state, and then, light radiation and the like are carried out under a condition in which a polymerization reaction of only one polymerizable group proceeds, thereby forming a pre optical anisotropic layer. Next, mask exposure is carried out under a condition in which the polymerization of the other polymerizable group is allowed (for example, in the presence of a polymerization initiator initiating the polymerization of the other polymerizable group). The orientation state of the exposed portion is fully fixed, and a phase difference region having a predetermined Re is formed. In a non-exposed region, the reaction of one reactive group proceeds, but the other reactive group remains unreacted. Therefore, when the discotic liquid crystal compound is heated to a temperature that is higher than the isotropic phase temperature and allows the reaction of the other reactive group to proceed, the non-exposed region is fixed in an isotropic phase state, that is, Re reaches 0 nm.

Supporter:

Regarding the supporter (supporter film) available in the invention, there is no particular limitation with the material. A polymer film having a low retardation is preferably used, and specifically, a film having an absolute value of the in-plane retardation of approximately 10 nm or less is preferably used. In an aspect in which a protective film for a polarization film is disposed between the polarization film and the patterned phase difference film as well, a polymer film with a low retardation is preferably used as the protective film, and the specific range is as described above.

Examples of a material forming the supporter available in the invention include polyester-based polymers such as polycarbonate-based polymers, polyethylene terephthalate and polyethylene naphthalate, acrylic polymers such as polymethyl methacrylate, styrene-based polymers such as polystyrene, and acrylonitrile and styrene copolymer (AS resin), and the like. In addition, examples thereof also include polyolefins such as polyethylene and polypropylene, polyolefin-based polymers such as ethylene and propylene copolymers, amide-based polymers such as norbornene-based polymers, vinyl chloride-based polymers, nylon and aromatic polyamides, imide-based polymers, sulfone-based polymers, polyether sulfone-based polymers, polyether ether ketone-based polymers, polyphenylene sulfide-based polymers, vinylidene chloride-based polymers, vinyl alcohol-based polymers, vinyl butyral-based polymers, arylate-based polymers, polyoxy methylene-based polymers, epoxy-based polymers, and polymers obtained by mixing the above-described polymers. In addition, the high molecular film of the invention can also be formed as a cured layer of an ultraviolet curing or thermosetting resin such as acrylic resin, urethane-based resin, acryl urethane-based resin, epoxy-based resin or silicone-based resin.

In addition, as a material for the film, it is possible to preferably use a cellulose acylate-based polymer, a polyester-based polymer, an acryl-based polymer and a norbornene-based polymer. Among the norbornene-based polymers, a thermoplastic norbornene-based resin can be preferably used. Examples of the thermoplastic norbornene-based resin include ZEONEX, ZEONOR (manufactured by ZEON Corporation), ATONE (manufactured by JSR Corporation), and the like.

In addition, as a material for the film, it is possible to preferably use a cellulose-based polymer (hereinafter referred to as cellulose acylate) represented by triacetyl cellulose which has thus far been used as a transparent protective film of the related art for the polarization plate.

The film configuring the supporter may contain a sugar ester, a polycondensation ester, a retardation expression agent, an antioxidant, a peeling accelerator, fine particles, a thermal deterioration inhibitor, an ultraviolet absorbent and the like within the scope of the spirit of the invention.

Examples of the sugar ester can be referenced from paragraphs [0050] to [0080] of JP2012-226276A, and the content thereof is incorporated in the specification. The addition of the sugar ester facilitates the adjustment of moisture permeability or moisture content by supplying hydrophobicity or facilitates the adjustment of mechanical properties by supplying plasticity. In the invention, a sugar ester having 1 to 12 pyranose structures or furanose structures in which at least one hydroxyl group turns into an aromatic ester is particularly preferred. Among the above-described sugar esters, the following sugar ester is preferably used.

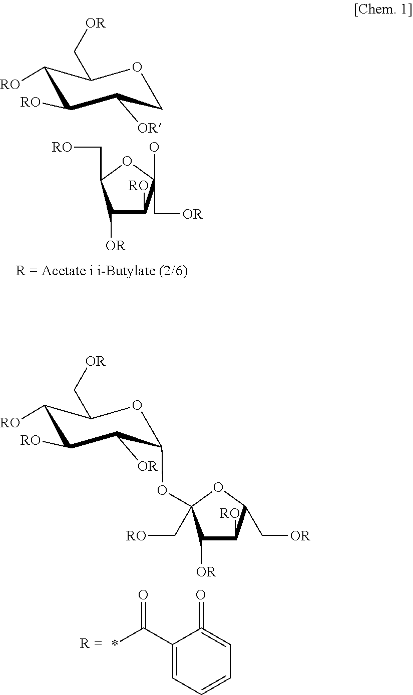

The retardation expression agent is preferably a nitrogen-containing aromatic compound. Examples of the retardation expression agent can be referenced from paragraphs [0081] to [0109] of JP2012-226276A, and the content thereof is incorporated in the specification.

Other additives can be referenced from paragraphs [0109] to [0112] of JP2012-226276A, and the content thereof is incorporated in the specification. In addition, the compounds described in the pamphlet of WO2008/126535A can be employed.

Examples of the ultraviolet absorbent can be referenced from paragraphs [0059] to [0135] of JP2006-199855A, and the content thereof is incorporated in the specification.

Method for Manufacturing the Supporter:

The method and facility for manufacturing the supporter used in the invention are not particularly limited, and, for example, a solution casting film-making method and a solution casting film-making apparatus which are provided to the manufacturing of a cellulose triacetate film of the related art can be used.

In a case in which the supporter is made of a cellulose acylate-based film, the supporter can be obtained by making a film using the above-described cellulose acylate solution.

In a case in which the supporter is made of a cellulose acylate-based film, and a plurality of cellulose acylate solutions is cast, a film may be produced while a solution containing cellulose acylate is respectively cast and laminated from a plurality of casting openings provided at intervals in the traveling direction of a metal supporter, and it is possible to apply, for example, the methods described in JP1986-158414A (JP-S61-158414A), JP1989-122419A (JP-H1-122419A), JP1999-198285A (JP-H11-198285A), and the like. In addition, the cellulose acylate solution may be made into a film by casting the cellulose acylate solution from two casting openings, and it is possible to carry out the methods described in JP1985-27562B (JP-S60-27562B), JP1986-94724A (JP-S61-94724A), JP1986-947245A (JP-S61-947245A), JP1986-104813A (JP-S61-104813A), JP1986-158413A (JP-S61-158413A), and JP1994-134933A (JP-H6-134933A). In addition, the method for casting a cellulose acylate film described in JP1981-162617A (JP-S56-162617A) in which the flow of a high-viscosity cellulose acylate solution is encompassed using a low-viscosity cellulose acylate solution, and the high-viscosity cellulose acylate solution and the low-viscosity cellulose acylate solution are extruded at the same time may be used. Furthermore, it is also a preferred aspect to contain a large amount of an alcohol component in which the outside solution is a poorer solvent than the inside solution as described in JP1986-94724A (JP-S61-94724A) and JP1986-94725A (JP-S61-94725A). Alternatively, it is also possible to peel a film molded into a metal supporter from a first casting opening using two casting openings and produce a film by carrying out second casting on a side in contact with the metal supporter surface, and an example thereof is the method described in JP1953-20235B (JP-S44-20235B).

The supporter is preferably manufactured using co-casting in which a high-viscosity solution can be extruded onto a metal supporter at the same time by casting a plurality of cellulose acylate solutions from casting openings, a film having an excellent surface shape with an improved flatness can be produced, furthermore, the drying load can be reduced using a high-concentration cellulose acylate solution, and the production speed of the film can be increased.

In the case of co-casting, there is no particular limitation with the thicknesses of the inside and the outside, but the outside is preferably in a range of 1% to 50%, and more preferably in a range of 2% to 30% of the total film thickness. Here, in the case of co-casting of three or more layers, the total film thickness of a layer in contact with a metal supporter and a layer in contact with air is defined as the thickness of the outside. The detail of the co-casting can be referenced from JP2011-127127A.

[Casting]

As the method for casting a solution, there are a method in which a prepared dope is uniformly extracted onto a metal supporter from a pressurization die, a method using a doctor blade in which the thickness of a dope temporarily cast on a metal supporter is adjusted using a blade, a method using a reverse roll coater in which the thickness is adjusted using a reversely-rotating roll, and the like, and the method using a pressurization die is preferred. As the pressurization die, there are a coat hanger-type die, a T die-type die, and the like, and any of the above-described dies can be preferably used. Furthermore, in addition to the above-described methods, it is possible to carry out a variety of methods that have been thus far known in which a film is made by casting a cellulose acetate solution, and the same effects as described in individual publications can be obtained by setting individual conditions in consideration of the differences in the boiling point and the like and solvents being used.

As the metal supporter that is used to manufacture the supporter and travels endlessly, a drum having a surface mirrored through chromium plating or a band (stainless steel belt) mirrored through surface polishing is used. The number of the pressurization die used for the manufacturing of the supporter which is installed above the metal supporter may be one or more, and is preferably one or two. In a case in which two or more pressurization dies are installed, the amount of a dope to be cast may be divided into a variety of fractions and assigned to individual dies, or a dope may be sent to the dies from a plurality of precise quantitative gear pumps in individual fractions. The temperature of the cellulose acylate solution used in the casting is preferably in a range of −10° C. to 55° C., and more preferably in a range of 25° C. to 50° C. In this case, the temperature may be equal throughout all the steps, or may be different at individual steps. In a case in which the temperature is different at individual steps, the temperature is required to be a desired temperature immediately before the casting.

In addition, the casting rate is preferably in a range of 20 m/minute to 200 m/minute, more preferably in a range of 40 m/minute to 160 m/minute, and particularly preferably in a range of 60 m/minute to 120 m/minute. When the casting rate is set in the above-described range, it is possible to manufacture a supporter having excellent linearity.

[Drying]

The dope is dried on the metal supporter, which is used for the manufacturing of the supporter, using a method in which hot air is blown from the front surface side of the metal supporter (a drum or a belt), that is, the front surface of a web on the metal supporter, a method in which hot air is blown from the back surface of the drum or the belt, or a back surface liquid heat transfer method, and it is normal to dry the dope using a method in which hot air is blown.

The temperature during the drying is preferably in a range of 70° C. to 220° C., more preferably in a range of 80° C. to 180° C., and particularly preferably in a range of 90° C. to 160° C.

Meanwhile, the surface temperature of the metal supporter before being cast may be any temperature as long as the temperature is equal to or lower than the boiling point of a solvent being used in the dope. However, in the initial phase of the drying, the surface temperature is preferably set to a temperature that is 1° C. to 10° C. lower than the boiling point of a solvent having the lowest boiling point among solvents being used in order to accelerate the drying or to remove the fluidity on the metal supporter. When the temperature of the hot air is within the above-described range, it is possible to manufacture a supporter having excellent linearity.

[Stretching Treatment]

For the supporter, it is possible to adjust the retardation through a stretching treatment as necessary. Furthermore, there is another method in which the supporter is actively stretched in a width direction, which is described in, for example, JP1971-115035A (JP-S62-115035A), JP1992-152125A (JP-H4-152125A), JP1992-284211A (JP-H4-284211A), JP1992-298310A (JP-H4-298310A), JP1999-48271A (JP-H11-48071A), and the like.

Method for Manufacturing the Patterned Phase Difference Plate:

As the method for manufacturing the patterned phase difference plate, for example, a long film (supporter) rolled in a roll shape is sent out, is transported under the application of a desired tensile stress, a pattern is exposed to continuously form first and second phase difference regions on the surface of the film, and a long patterned phase difference plate is continuously manufactured. If desired, the patterned phase difference plate may be rolled in a roll shape again, and reserved and transported in a roll shape, or the patterned phase difference plate may be produced using a so-called roll-to-roll process.

An example of the method for manufacturing the patterned phase difference plate is as described below.

The method includes a step of forming an orientation film treated to be uniaxially oriented on a long film, a first exposure step of forming a coated layer of a curable liquid crystal composition containing a liquid crystal as a main component on the orientation film, orienting the liquid crystal in the coated layer in parallel with or orthogonally to an orientation treatment direction, and then exposing a pattern, thereby forming first phase difference regions on the exposed portion, and a second exposure step of orienting the liquid crystal in the coated layer in a non-exposed portion in a direction different from the orientation treatment direction (for example, an orthogonal or parallel direction), and then exposing the pattern, thereby forming second phase difference regions.

The respective steps are carried out while the film is transported under the application of a predetermined tensile stress. The respective steps are carried out in a state in which the long film is stretched due to the tensile stress. The predetermined tensile stress is preferably in a range of 10 N/m to 800 N/m, more preferably in a range of 15 N/m to 600 N/m, and particularly preferably in a range of 20 N/m to 400 N/m. Meanwhile, in a case in which a tensile stress in a range of 10 N/m to 800 N/m is applied to the supporter (long film), while there is a tendency that the change rate of the linearity at the edge of the supporter by the application of the tensile stress increases as the linearity at the edge of the supporter is poorer, when the linearity at the edge of the supporter is 0.0195% or less, the change rate of the linearity at the edge of the supporter by the application of the tensile stress is small, and therefore it is possible to significantly reduce the deterioration degree of the linearity of an optical anisotropic layer due to the application of the tensile stress.

The first exposure step is carried out using a mask or the like having an opening section. In the second exposure step, the full surface may be exposed, or only the non-exposed portions which correspond to the second phase difference regions may be exposed using another mask.

Another example is as described below.

The method includes a step of forming an orientation film treated to be uniaxially oriented on a long film, a pattern exposure step of exposing the pattern of the orientation film, and forming a first orientation control region having a different orientation control capability from an orientation control capability generated by an orientation treatment in an exposed portion and a second orientation control region having the orientation control capability generated by the orientation treatment in a non-exposed portion, a step of forming a coated layer of a curable liquid crystal composition containing a liquid crystal as a main component on the orientation film, orienting the liquid crystal in the coated layer in mutually different directions using the orientation control capability of each of the first orientation control region and the second orientation control region, and a step of fixing an orientation state while maintaining the orientation state, and forming first and second phase difference regions.

The respective steps are carried out while the film is transported under the application of a predetermined tensile stress. The respective steps are carried out in a state in which the long film is stretched due to the tensile stress. The predetermined tensile stress is preferably in a range of 10 N/m to 800 N/m, more preferably in a range of 15 N/m to 600 N/m, and particularly preferably in a range of 20 N/m to 400 N/m.

In addition, the pattern exposure step in the above-described method is carried out using a mask having an opening portion or the like.

There is no particular limitation with the thickness of the patterned optical anisotropic layer formed in the above-described manner, but the thickness is preferably in a range of 0.1 μm to 10 μm, and more preferably in a range of 0.5 μm to 5 μm.

Polarization Film:

An ordinary polarization film can be used as the polarization film. For example, a polarizer film made of a polyvinyl alcohol film or the like dyed with iodine or a dichromatic pigment can be used.

Adhesive Layer:

An adhesive layer may be disposed between the optical anisotropic layer and the polarization film. The adhesive layer used to laminate the optical anisotropic layer and the polarization film refers to, for example, a substance having a ratio (tan δ=G″/G′) of G″ to G′ measured using a dynamic viscoelasticity measurement apparatus in a range of 0.001 to 1.5, and includes so-called an adhesive, easily-creeping substances and the like. There is no particular limitation with the adhesive, and it is possible to use, for example, a polyvinyl alcohol-based adhesive.

Liquid Crystal Cell:

The liquid crystal cell used in the stereoscopic image display device and the stereoscopic image display system of the invention is preferably a VA-mode liquid crystal cell, an OCB-mode liquid crystal cell, an IPS-mode liquid crystal cell or a TN-mode liquid crystal cell, but the cell is not limited thereto.

In the TN-mode liquid crystal cell, when no voltage is applied, the rod-shaped liquid crystal molecules are oriented substantially horizontally, and furthermore, are twisted at an angle in a range of 60° to 120°. The TN-mode liquid crystal cell is most widely used in a color TFT liquid crystal display device, and is described in a number of publications.

In the VA-mode liquid crystal cell, when no voltage is applied, the rod-shaped liquid crystal molecules are oriented substantially vertically. Examples of the VA-mode liquid crystal cell include (1) a narrowly-defined VA-mode liquid crystal cell (described in JP1990-176625A (JP-H2-176625A)) in which the rod-shaped liquid crystal molecules are oriented substantially vertically when no voltage is applied, and are oriented substantially horizontally when a voltage is applied, (2) an (MVA-mode) liquid crystal cell obtained by making the VA mode into multi domains to enlarge the view angle (described in SID97, Digest of tech. Papers (proceedings) 28 (1997) 845), (3) an (n-ASM-mode) liquid crystal cell in which the rod-shaped liquid crystal molecules are oriented substantially vertically when no voltage is applied, and are twisted and oriented in multi domains when a voltage is applied (described in proceedings 58 to 59 (1998) of JLCS Conference), and (4) a SURVIVAL-mode liquid crystal cell (presented at LCD International 98). In addition, the VA-mode liquid crystal cell may be a patterned vertical alignment (PVA)-type liquid crystal cell, an optical alignment-type liquid crystal cell, or a polymer-sustained alignment (PSA)-type liquid crystal cell. The details of the above-described mode are described in JP2006-215326A and JP2008-538819A.

In the IPS-mode liquid crystal cell, the rod-shaped liquid crystal molecules are oriented substantially in parallel with the substrate, and the liquid crystal molecules are responded in a planar manner when an electric field in parallel with the substrate surface is applied. The IPS mode displays black in a state in which no electric field is applied, and the absorption axes in a pair of top and bottom polarization plates are orthogonal to each other. Methods for improving the view angle by reducing light leakage in an inclined direction while black is displayed using an optical compensation sheet are described in JP1998-54982A (JP-H10-54982A), JP1999-202323A (JP-H11-202323A), JP 1997-292522A (JP-H9-292522A), JP1999-133408A (JP-H11-133408A), JP1999-305217A (JP-H11-305217A), JP1998-307291A (JP-H10-307291A), and the like.

Polarization Plate for the Stereoscopic Image Display System:

In the stereoscopic image display system of the invention, an image is recognized through the polarization plate to let a viewer recognize a stereoscopic image particularly called a 3D image. An aspect of the polarization plate is polarization glasses. In an aspect in which circularly-polarized images for the right eye and the left eye are formed using the phase difference plate, circularly-polarized glasses are used, and in an aspect in which linearly-polarized images are formed, linear glasses are used. The polarization glasses are preferably configured so that image light for the right eye emitted from any one of the first and second phase difference regions in the optical anisotropic layer penetrates right eye glass and is blocked by left eye glass, and image light for the left eye emitted from the other of the first and second phase difference regions penetrates the left eye glass and is blocked by the right eye glass.

The polarization glasses forms polarization glasses by including a phase difference functional layer and a linear polarizer. Meanwhile, other members having the same function as the linear polarizer may be used.

A specific configuration of the stereoscopic image display system of the invention which includes the polarization glasses will be described. First, in the phase difference plate, the first phase difference region and the second phase difference region having different polarization conversion functions are provided on a plurality of first lines and a plurality of second lines (for example, on odd-number lines and even-number lines in the horizontal direction when the lines are along the horizontal direction, and on odd-number lines and even-number lines in the vertical direction when the lines are along the vertical direction) in which image display panels are alternately repeated. In a case in which circularly-polarized light is used for displaying, the phase differences in both the first phase difference region and the second phase difference region are preferably λ/4, and the slow axes are more preferably orthogonal to each other in the first phase difference region and the second phase difference region.

In a case in which circularly-polarized light is used, the phase differences are set to λ/4 in both the first phase difference region and the second phase difference region, and an image for the right eye is displayed on the odd-number lines in the image display panel. When the slow axis in the odd-number line phase difference region is in a 45-degree direction, it is preferable to dispose λ/4 plates both in the right eye glass and the left eye glass of the polarization glasses, and the slow axis of the λ/4 plate in the right eye glass of the polarization glasses may be fixed at, specifically, approximately 45 degrees. In addition, in the above-described status, similarly, when an image for the left eye is displayed on the even-number lines of the image display panel, and the slow axis in the even-number line phase difference region is in a 135-degree direction, the slow axis in the left eye glass of the polarization glasses may be fixed at, specifically, approximately 135 degrees.

Furthermore, in the above-described example, the angle of the slow axis fixing the right eye glass is preferably close to accurately 45 degrees in the horizontal direction from the viewpoint that, in the patterned phase difference film, image light is emitted once as circularly-polarized light and the polarization state is returned to the original state using the polarization glasses. In addition, the angle of the slow axis fixing the left eye glass is preferably close to accurately 135 degrees (or −45 degrees) horizontally.

In addition, in a case in which the image display panel is, for example, a liquid crystal display panel, the absorption axis direction of the front polarization plate in the liquid crystal display panel is generally the horizontal direction, the absorption axis in a linear polarizer in the polarization glasses is preferably in a direction orthogonal to the absorption axis direction of the front polarization plate, and the absorption axis in the linear polarizer in the polarization glasses is more preferably in the vertical direction.

In addition, the absorption axis direction of the front polarization plate in the liquid crystal display panel and the respective slow axes in the odd-number line phase difference regions and the even-number line phase difference regions in the patterned phase difference film preferably form 45 degrees in terms of the polarization conversion efficiency.

Meanwhile, the preferable disposition of the polarization glasses, the patterned phase difference film, and the liquid crystal display device is disclosed in, for example, JP2004-170693A.

Examples of the polarization glasses include the polarization glasses described in JP2004-170693A and commercially available products such as an accompanying item of ZM-M220W (manufactured by Zalman Tech co., Ltd.) and an accompanying item of 55LW5700 (manufactured by LG Electronics).

### EXAMPLES

The invention will be described in more detail based on the following examples. Materials, the use amounts, the proportions, the treatment contents, the treatment orders and the like described in the following examples can be altered as appropriate within the scope of the technical concept of the invention. Therefore, the ranges of the invention are not supposed to be interpreted restrictively by the examples described below.

The linearity of the optical anisotropic layer was determined as described below.

Twenty patterned phase difference plates having horizontal and vertical sizes that were 5 mm larger than the screen size of a display device respectively were prepared by punching an FPR film into two segments in the width direction of the FPR film roll from locations 50 mm away from both edge surfaces of the roll, and by punching the FPR film at intervals of three meters along the length of the roll. A point 40 mm away from an initial point of a boundary portion between first and second phase difference regions in the patterned phase difference plate was defined as point A, a point 40 mm away from a terminal point at the other edge was defined as point B, and a straight line combining the points A and B was drawn.

Next, the lengths of individual perpendicular lines to the straight line combining the points A and B which passed through the points approximately 40 mm away from both edge sides (the points A and B) and the center along the short side of the film were measured using a precise scale or a measurement device.

The above-described operation was carried out on the 20 punched patterned phase difference plates, and based on the length of the image display panel in the vertical direction, the ratio of the length of the longest perpendicular line to the length of the image display panel in the vertical direction was used as the linearity of the patterned optical anisotropic layer.

That is, in the case of the patterned phase difference plate attached to a 32ZP2 manufactured by Toshiba, the screen sizes of the 32ZP2 manufactured by Toshiba were 697.3 mm in width and 392.3 mm in length, and therefore patterned phase difference plates having a length of 702.3 mm and a width of 397.3 mm were punched, and the linearity at a pattern length of 622.3 mm was evaluated. In the case of a 55LW5700 manufactured by LG Electronics, the screen sizes of the 55LW5700 manufactured by LG Electronics were 1209 mm in width and 679.9 mm in length, and therefore FPR films having a length of 1214 mm and a width of 684.9 mm were punched, and the linearity at a pattern length of 1134 mm was measured.

The linearity at the edge of the supporter was determined as described below.

In the edges of the supporter roll, the initial point A on one edge and the terminal point B on the other edge were defined within the length range of the screen in the display device in the longitudinal direction, and a straight line combining the points A and B was drawn.

A line perpendicular to the straight line combining the points A and B was drawn, and the length of the perpendicular line was measured using a precise scale or measurement device.

The same measurement was carried out at 10 positions at intervals of three meters in the vertical direction of the supporter roll, and the ratio of the length of the longest perpendicular line to the length of the image display panel in the vertical direction was considered as the linearity at the edge of the supporter using the length of the image display panel in the vertical direction as the criterion.

That is, in the case of an FPR film attached to a 32ZP2 manufactured by Toshiba, the screen sizes of the 32ZP2 manufactured by Toshiba were 697.3 mm in width and 392.3 mm in length, and therefore the linearity per 697.3 mm was evaluated. In the case of an FPR film attached to a 55LW5700 manufactured by LG Electronics, the screen sizes of the 55LW5700 manufactured by LG Electronics were 1209 mm in width and 679.9 mm in length, and therefore the linearity per 1209 mm was measured.

The linearity of the surface film (that is, a transparent supporter equipped with an antireflection layer) was also measured in the same manner.

### Example 1

### Production of a Transparent Supporter a

The following composition was injected into a mixing tank, and stirred under heating so as to dissolve individual components, thereby preparing a cellulose acetate solution (dope C) having a solid content concentration of 22% by mass.

(Composition of the Cellulose Acetate Solution)

| | |
|---|---|
| Cellulose acetate having an acetylation degree in | 100 parts by mass |
| a range of 60.7% to 61.1% | |
| Triphenyl phosphate (plasticizer) | 7.8 parts by mass |
| Biphenyl diphenyl phosphate (plasticizer) | 3.9 parts by mass |
| Ultraviolet absorber (TINUVIN 328 | 0.9 parts by mass |
| manufactured by BASF Japan Ltd.) | |
| Ultraviolet absorber (TINUVIN 326 | 0.2 parts by mass |
| manufactured by BASF Japan Ltd.) | |
| Methylene chloride (first solvent) | 336 parts by mass |
| Methanol (second solvent) | 29 parts by mass |
| 1-butanol (third solvent) | 11 parts by mass |

A matting agent-added dope D was prepared by adding 0.02 parts by mass of silica particles having an average particle diameter of 16 nm (AEROSIL R972, manufactured by Nippon aerosol Co., Ltd.) to the dope C with respect to 100 parts by mass of cellulose acetate. The dope D was adjusted so that the solid content concentration became 19% by mass at the same solvent composition as the dope C.

The dope C was used as the main stream, the matting agent-added dope D was used to form the bottom layer and the top layer, and casting was carried out using a band stretching device. Once the film surface temperature reached 40° C. on the band, the film was dried for one minute using hot air (70° C.), the film was peeled from the band, was dried using drying air (140° C.), and then, both edges were cut off so as to obtain a film width of 1340 mm, thereby producing a roll of a transparent supporter A having a residual solvent amount of 0.3% by mass and a length of 4000 m or more. Meanwhile, the flow rate during the casting was adjusted so that the matting agent-added bottom layer and top layer reached 3 μm respectively and the main stream reached 74 μm.

The linearity per length of the obtained transparent supporter A of 697.3 mm was 74 μm.

<Production of Transparent Supporters B and C>

Transparent supporters B and C were produced using the same method as for the transparent supporter A except for the facts that, in the production of the transparent supporter A, the film casting rate was changed in addition to the change of the roll core of the band stretching device and the adjustment of the intensity of the air during the film drying.

The obtained transparent supporters B and C had linearity of 92 μm and 32 μm respectively at the roll edges per length of 697.3 mm.

<Production of Transparent Supporters D to F>

A transparent supporter D was produced using the same method as for the transparent supporter A except for the facts that, in the production of the transparent supporter A, the intensity of the air during the film drying was adjusted, the film casting rate was changed, and furthermore, both edges were cut off so as to obtain a film width of 1490 mm.

Transparent supporters E and F were produced using the same method as for the transparent supporter D except for the fact that, in the production of the transparent supporter D, the film casting rate was changed in addition to the changing of the roll core of the band stretching device and the adjustment of the intensity of the air during the film drying.

The obtained transparent supporters D to F have linearity of 126 μm, 165 μm, and 74 μm respectively at the roll edges per length of 1209 mm.

<Production of a Transparent Supporter M>

A commercially available cellulose acylate-based supporter TD80UL (manufactured by Fujifilm Corporation) was prepared, and was used as a transparent supporter M. Five rolls of the transparent supporter M were prepared, and the linearity at the roll edge was measured per length of 697.3 mm, and was consequently 91 μm.

<Production of a Transparent Supporter N>

A commercially available cellulose acylate-based supporter TD80UL (manufactured by Fujifilm Corporation) was prepared, and was used as a transparent supporter N. Five rolls of the transparent supporter N were prepared, and the linearity at the roll edge was measured per length of 1209 mm, and was consequently 163 μm.

<Production of a Transparent Supporter R>

(Preparation of a Cellulose Ester Solution for an Air Layer)

The following composition was injected into a mixing tank, and stirred under heating so as to dissolve individual components, thereby preparing a cellulose ester solution for an air layer.

The composition of the cellulose acetate solution for an air layer

| | |
|---|---|
| Cellulose ester (having an acetyl substitution | 100 parts by mass |
| degree of 2.86) | |
| Sugar ester compound of Formula (R-I) | 3 parts by mass |
| Sugar ester compound of Formula (R-II) | 1 part by mass |
| The following ultraviolet absorber | 2.4 parts by mass |
| Silica particle dispersion solution (having an | 0.026 parts by mass |
| average particle diameter of 16 nm) | |
| “AEROSIL R972,” manufactured | |
| by Nippon aerosol Co., Ltd. | |
| Methylene chloride | 339 parts by mass |
| Methanol | 74 parts by mass |
| Butanol | 3 parts by mass |

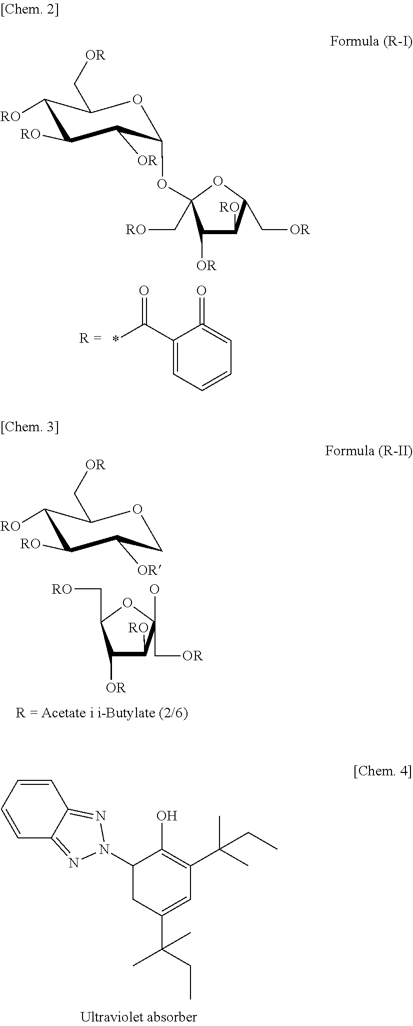

(Preparation of a Cellulose Ester Solution for a Drum Layer)

The following composition was injected into a mixing tank, and stirred under heating so as to dissolve individual components, thereby preparing a cellulose ester solution for a drum layer.

The composition of the cellulose acetate solution for a drum layer

| | |
|---|---|
| Cellulose ester (having an acetyl substitution | 100 parts by mass |
| degree of 2.86) | |
| Sugar ester compound of Formula (R-I) | 3 parts by mass |
| Sugar ester compound of Formula (R-II) | 1 part by mass |
| Ultraviolet absorber | 2.4 parts by mass |
| Silica particle dispersion solution (having an | 0.091 parts by mass |
| average particle diameter of 16 nm) | |
| “AEROSIL R972,” manufactured by | |
| Nippon Aerosol Co., Ltd. | |
| Methylene chloride | 339 parts by mass |
| Methanol | 74 parts by mass |
| Butanol | 3 parts by mass |

(Preparation of a Cellulose Ester Solution for a Core Layer)

The following composition was injected into a mixing tank, and stirred under heating so as to dissolve individual components, thereby preparing a cellulose ester solution for a core layer.

The composition of the cellulose acetate solution for a core layer

| | |
|---|---|
| Cellulose ester (having an acetyl substitution | 100 parts by mass |
| degree of 2.86) | |
| Sugar ester compound of Formula (R-I) | 8.3 parts by mass |
| Sugar ester compound of Formula (R-II) | 2.8 parts by mass |
| The above-described ultraviolet absorber | 2.4 parts by mass |
| Methylene chloride | 266 parts by mass |
| Methanol | 58 parts by mass |
| Butanol | 2.6 parts by mass |

(Film Making Through Co-Casting)

As a casting die, an apparatus equipped with a feed block adjusted to be suitable for co-casting use so as to become capable of molding a three layer-structured film was used. The above-described cellulose ester solution for an air layer, cellulose ester solution for a core layer, and cellulose ester solution for a drum layer were co-cast on a drum cooled to −7° C. from a casting opening. At this time, the flow rates of the respective dopes were adjusted so that the thickness ratio became 7/90/3 (the air layer/the core layer/the drum layer).

The solutions were cast onto the mirrored stainless steel supporter which was a drum having a diameter of 3 m. Drying air (34° C.) was blown to the drum at 270 m³/minute.

In addition, the cast and rotated cellulose film was peeled from the drum 50 cm before the terminal portion of a cast portion, and then both edges were clipped using pin stenters. During the peeling, the cellulose film was stretched as much as 5% in a transportation direction (longitudinal direction).

A cellulose ester web held using the pin stenters was transported to a drying zone. During the initial drying, 45° C. drying air was blown, and then the cellulose ester web was dried at 110° C. for five minutes. At this time, the cellulose ester web was blown while being stretched in the width direction at a magnification of 10%.

When the web was removed from the pin stenters, portions held by the pin stenters were continuously cut, and a recess and a protrusion having a width of 15 mm and a height of 10 μm were provided at both edges of the web in the width direction. At this time, the width of the web was 1610 mm. The web was dried at 140° C. for ten minutes under the application of a tensile stress of 210 N in the transportation direction. Furthermore, the edges in the width direction were continuously cut so as to obtain a desired width of the web, thereby producing a transparent supporter R having a film thickness of 40 μm. At this time, the edges in the width direction cut after the drying at 140° C. and the web central portion had the same film thickness.

The obtained transparent supporter R had a linearity of 126 μm at the roll edge per length of 1209 mm.

<Production of Transparent Supporters S and T>

Transparent supporters S and T were produced using the same method as for the transparent supporter R except for the facts that, in the production of the transparent supporter R, the film casting rate was changed in addition to the change of the transportation roll core in a drum film-making device and the adjustment of the intensity of the air during the film drying.

The obtained transparent supporters S to T had linearity of 165 μm and 74 μm respectively at the roll edges per length of 1209 mm.

<Production of a Surface Film G>

(Preparation of a Sol Solution a)

After 120 parts by mass of methyl ethyl ketone, 100 parts by mass of acryloyloxy propyl trimethoxysilane (KBM-5103, manufactured by Shin-Etsu Chemical Co., Ltd.), and 3 parts by mass of diisopropoxyaluminum ethyl acetoacetate were added to and mixed in a reactor having a stirring device and a reflux cooling device, 30 parts by mass of ion exchange water was added, and the components were reacted at 60° C. for four hours, and then were cooled to room temperature, thereby obtaining a sol solution a. The mass average molecular weight was 1600, and out of oligomer or higher components, components having a molecular weight in a range of 1000 to 20000 accounted for 100%. In addition, the gas chromatography analysis showed that no acryloyloxy propyl trimethoxysilane used as the raw material remained.

(Preparation of a Coating Solution for an Anti-Glare Layer)

31 g of a mixture of pentaerythritol triacrylate and pentaerythritol tetraacrylate (PET-30, manufactured by Nippon Kayaku Co., Ltd.) was diluted using 38 g of methyl isobutyl ketone. Furthermore, 1.5 g of a polymerization initiator (IRGACURE184 manufactured by Ciba Specialty Chemicals Inc.) was added, and the components were mixed and stirred. Subsequently, 0.04 g of a fluorine-based surface modifier (FP-148) and 6.2 g of a silane coupling agent (KBM-5103, manufactured by Shin-Etsu Chemical Co., Ltd.) were added. The refractive index of a coated film obtained through the coating and ultraviolet curing of the solution was 1.520. Finally, 39.0 g of a 30% cyclohexanone dispersion solution of crosslinked poly(acryl-styrene) particles (with a copolymerization composition ratio of 50/50 and a refractive index of 1.540) having an average particle diameter of 3.5 μm which were dispersed at 10000 rpm for 20 minutes in the solution using a polytron disperser was added, thereby producing a completed solution. The solution mixture was filtered using a polypropylene filter having a pore diameter of 30 μm, thereby preparing a coating solution for an anti-glare layer.

| 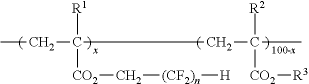 | | | | | | [Chem. 5] |
|---|---|---|---|---|---|---|
| | x | R¹ | n | R² | R³ | Mw |
| FP-148 | 80 | H | 4 | CH₃ | CH₃ | 11000 |

(Preparation of a Coating Solution for a Low-Refractive Index Layer)

13 g of a thermally crosslinkable fluorine-containing polymer (JTA113 with a solid content concentration of 6%, manufactured by JSR Corporation) with a refractive index of 1.44 containing polysiloxane and a hydroxyl group, 1.3 g of a colloidal silica dispersion solution MEK-ST-L (product name, having an average particle diameter of 45 nm, 1.3 g of a solid content concentration of 30%, manufactured by Nissan Chemical Industries, Ltd.), 0.6 g of the sol solution a, 5 g of methyl ethyl ketone, and 0.6 g of cyclohexanone were added and stirred, and then the mixture was filtered using a polypropylene filter having a pore diameter of 1 μm, thereby preparing a low-refractive index coating solution. The refractive index of a layer formed using the coating solution was 1.45.

(1) Provision of an Anti-Glare Layer Through Coating

The transparent supporter C was rolled in a roll form, the coating solution for an anti-glare layer was applied using a die coating method for which the apparatus configuration and the application conditions are described in paragraph [0172] in JP2007-41495A, was dried at 30° C. for 15 seconds and at 90° for 20 seconds, and furthermore, the coated layer was cured by radiating an ultraviolet ray at a radiation amount of 90 mJ/cm² using a 160 W/cm² air-cooling metal halide lamp (manufactured by Eye Graphics Co., Ltd.) under nitrogen purging, thereby forming a 6 μm-thick anti-glare layer having an anti-glare property.

(2) Provision of a Low-Refractive Index Layer Through Coating

A film provided with the anti-glare layer by applying the coating solution for an anti-glare layer was rolled again, the coating solution for a low-refractive index layer was applied under the basic conditions described in paragraph [0172] in JP2007-41495A, was dried at 120° C. for 15 seconds, and then, a 100 nm-thick low-refractive index layer was formed by radiating an ultraviolet ray at a radiation amount of 900 mJ/cm² using a 240 W/cm air-cooling metal halide lamp (manufactured by Eye Graphics Co., Ltd.) in an atmosphere with an oxygen concentration of 0.1% by volume through nitrogen purging while being dried at 140° C. for eight minutes, thereby obtaining a surface film G.

The obtained surface film G had a linearity of 73 μm at the roll edge per length of 697.3 mm.

<Production of Surface Films H to L>

Surface films H to L were produced using the same method for the surface film G except for the facts that, in the production of the surface film G, the treatment conditions such as the transportation rate and the tensile stress in the transportation direction during the provision of the anti-glare layer through coating and the treatment conditions such as the transportation rate and the tensile stress in the transportation direction during the provision of the low-refractive index layer through coating.

The obtained surface films H and I had linearity of 116 μm and 43 μm respectively at the roll edges per length of 697.3 mm. The obtained surface films J to L had linearity of 131 μm, 179 μm, and 49 μm respectively at the roll edges per length of 1209 mm.

<Production of a Surface Film U>

A surface film U was produced using the same method as for the surface film J except for the fact that, in the production of the surface film J, the transparent supporter C was changed to the transparent supporter T.

The obtained surface film U had a linearity of 131 μm at the roll edge per length of 1209 mm.

<Production of Surface Films V to W>

Surface films V and W were produced using the same method for the surface film U except for the fact that, in the production of the surface film U, the treatment conditions such as the transportation rate and the tensile stress in the transportation direction during the provision of the anti-glare layer through coating and the treatment conditions such as the transportation rate and the tensile stress in the transportation direction during the provision of the low-refractive index layer through coating.

The obtained surface films V to W had linearity of 179 μm and 49 μm respectively at the roll edges per length of 1209 mm.

[Production of a Patterned Phase Difference Plate A]

<Alkali Saponification Treatment>

The transparent supporter A was prepared, was made to pass through dielectric heating rolls at a temperature of 60° C., the temperature of the film surface was increased to 40° C., then, an alkali solution having the following composition was applied using a bar coater at an application amount of 14 ml/m², was heated at 110° C., and was transported for ten seconds. Subsequently, similarly, pure water was applied at 3 ml/m² using a bar coater. Next, water washing and water dripping using an air knife were repeated three times, and then the solution was dried by being transported in a 70° C. drying zone for ten seconds, thereby producing an alkali saponification-treated cellulose acetate transparent supporter.

The composition of the alkali solution (parts by mass)

| | |
|---|---|
| Potassium hydroxide | 4.7 parts by mass |
| Water | 15.8 parts by mass |
| Isopropanol | 63.7 parts by mass |
| Surfactant | |
| SF-1: C₁₄H₂₉O(CH₂CH₂O)₂₀H | 1.0 part by mass |
| Propylene glycol | 14.8 parts by mass |

<Production of a Rubbing Orientation Film-Attached Transparent Supporter>

A rubbing orientation film-attached coating solution having the following composition was applied to the saponification-treated surface of the produced supporter using a #8 wire bar. The solution was dried using 60° C. hot air for 60 seconds and furthermore, 100° C. hot air for 120 seconds, thereby forming an orientation film. Next, a stripe mask having a horizontal strip width in a transmission portion of 364 μm and a horizontal stripe width in a shield portion of 364 μm was disposed on the rubbing orientation film, and an ultraviolet ray was radiated for four seconds using a metal halide lamp an illumination of 2.5 mW/cm² in a UV-C region in the air at room temperature so as to decompose a photo-acid generating agent and generate an acidic compound, thereby forming an orientation layer first phase difference region. After that, a rubbing treatment was carried out reciprocally once in a single direction at 500 rpm at an angle held at 45° with respect to the stripes of a stripe mask, thereby producing a rubbing orientation film-attached transparent supporter. The film thickness of the orientation film was 0.5 μm. Meanwhile, the transportation tensile stress during the mask exposure in a manufacturing machine was 150 N/m.

The composition of the coating solution for forming the orientation film

| | |
|---|---|
| Polymer material for the orientation film | 3.9 parts by mass |
| (PVA103, polyvinyl alcohol manufactured by | |
| Kuraray Co., Ltd.) | |
| Photo-acid generation agent (S-2) | 0.1 parts by mass |
| Methanol | 36 parts by mass |
| Water | 60 parts by mass |

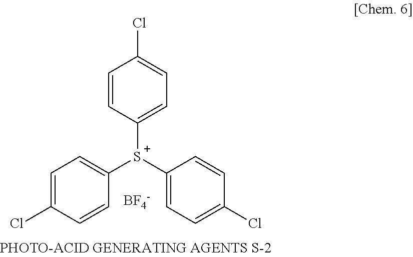

<Production of a Patterned Optical Anisotropic Layer>

The following coating solution for an optical anisotropic layer was applied at an application amount of 4 ml/m² using a bar coater. Next, the coating solution was heated and aged at a film surface temperature of 110° C. for two minutes, then, was cooled to 80° C., the orientation state was fixed by radiating an ultraviolet ray in the air for 20 seconds using a 20 mW/cm² UV metal halide lamp so as to form a patterned optical anisotropic layer, thereby producing a patterned phase difference plate A. A discotic liquid crystal was perpendicularly oriented so that the slow axis direction was in parallel with the rubbing direction in mask-exposed portions (first phase difference regions), and was perpendicularly oriented so that the slow axis direction was orthogonal to the rubbing direction in non-exposed portions (second phase difference regions). The film thickness of the optical anisotropic layer was 0.9 μm.

The composition of the coating solution for the optical anisotropic layer

| | |
|---|---|
| Discotic liquid crystal E-1 | 100 parts by mass |
| Orientation film interface orientation agent (II-1) | 3.0 parts by mass |
| Air interface orientation agent (P-1) | 0.4 parts by mass |
| Photopolymerization initiator | 3.0 parts by mass |
| (IRGACURE907 manufactured by Ciba | |
| Specialty Chemicals Inc.) | |
| Sensitizer (KAYACURE DETX, manufactured by | 1.0 part by mass |
| Nippon Kayaku Co., Ltd.) | |
| Methyl ethyl ketone | 400 parts by mass |

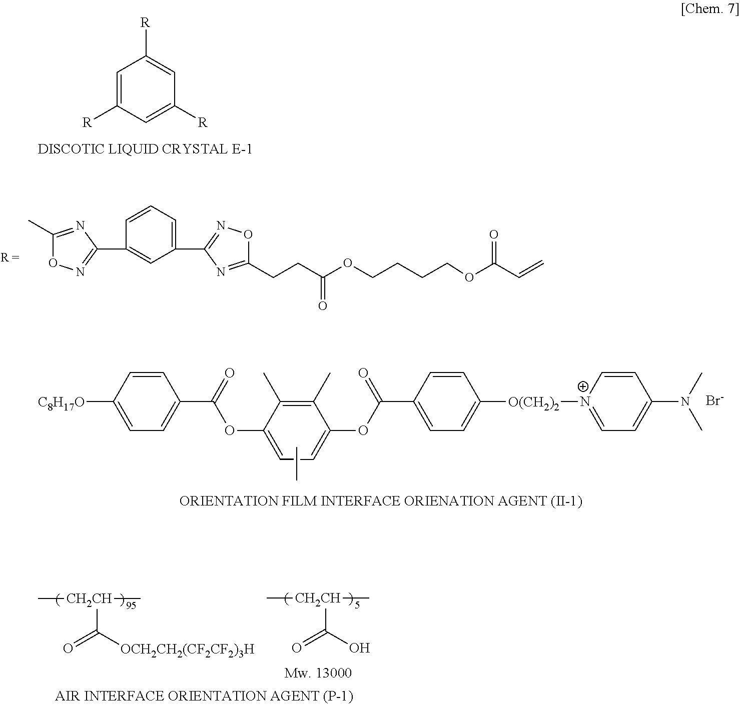

The obtained optical anisotroic layer A had a linearity of 25 μm per length of 622.3 mm.

[Production of a Patterned Phase Difference Plate B]

A patterned phase difference plate B was produced using the same method for the patterned phase difference plate A except for the fact that, in the production of the patterned phase difference plate A, the transparent supporter A was changed to the transparent supporter B.

The obtained optical anisotroic layer B had a linearity of 44 μm per length of 622.3 mm.

[Production of a Patterned Phase Difference Plate C]

A patterned phase difference plate C was produced using the same method for the patterned phase difference plate A except for the fact that, in the production of the patterned phase difference plate A, the transparent supporter A was changed to the transparent supporter C.

The obtained optical anisotroic layer C had a linearity of 9 μm per length of 622.3 mm.

[Production of a Patterned Phase Difference Plate D]

A patterned phase difference plate D was produced using the same method for the patterned phase difference plate A except for the fact that, in the production of the patterned phase difference plate A, the transparent supporter A was changed to the transparent supporter D.

The obtained optical anisotroic layer D had a linearity of 42 μm per length of 1134 mm.

[Production of a Patterned Phase Difference Plate E]

A patterned phase difference plate E was produced using the same method for the patterned phase difference plate A except for the fact that, in the production of the patterned phase difference plate A, the transparent supporter A was changed to the transparent supporter E.

The obtained optical anisotroic layer E had a linearity of 66 μm per length of 1134 mm.

[Production of a Patterned Phase Difference Plate F]

A patterned phase difference plate F was produced using the same method for the patterned phase difference plate A except for the fact that, in the production of the patterned phase difference plate A, the transparent supporter A was changed to the transparent supporter F.

The obtained optical anisotroic layer F had a linearity of 17 μm per length of 1134 mm.

[Production of a Patterned Phase Difference Plate G]

A patterned phase difference plate G having a patterned phase difference layer on a surface on which the anti-glare layer and the low-refractive index layer were formed was produced using the same method for the patterned phase difference plate A except for the fact that, in the production of the patterned phase difference plate A, the transparent supporter A was changed to the surface film G.

The obtained optical anisotroic layer G had a linearity of 19 μm per length of 622.3 mm.

[Production of a Patterned Phase Difference Plate H]

A patterned phase difference plate H was produced using the same method for the patterned phase difference plate G except for the fact that, in the production of the patterned phase difference plate G, the transparent supporter G was changed to the surface film H.

The obtained optical anisotroic layer H had a linearity of 51 μm per length of 622.3 mm.

[Production of a Patterned Phase Difference Plate I]

A patterned phase difference plate I was produced using the same method for the patterned phase difference plate G except for the fact that, in the production of the patterned phase difference plate G, the transparent supporter G was changed to the surface film I.

The obtained optical anisotroic layer I had a linearity of 10 μm per length of 622.3 mm.

[Production of a Patterned Phase Difference Plate J]

A patterned phase difference plate J was produced using the same method for the patterned phase difference plate G except for the fact that, in the production of the patterned phase difference plate G, the transparent supporter G was changed to the surface film J.

The obtained optical anisotroic layer J had a linearity of 44 μm per length of 1134 mm.

[Production of a Patterned Phase Difference Plate K]

A patterned phase difference plate K was produced using the same method for the patterned phase difference plate G except for the fact that, in the production of the patterned phase difference plate G, the transparent supporter G was changed to the surface film K.

The obtained optical anisotroic layer K had a linearity of 74 μm per length of 1134 mm.

[Production of a Patterned Phase Difference Plate L]

A patterned phase difference plate L was produced using the same method for the patterned phase difference plate G except for the fact that, in the production of the patterned phase difference plate G, the transparent supporter G was changed to the surface film L.

The obtained optical anisotroic layer L had a linearity of 10 μm per length of 1134 mm.

[Production of a Patterned Phase Difference Plate M]

A patterned phase difference plate M was produced using the same method for the patterned phase difference plate A except for the fact that, in the production of the patterned phase difference plate A, the transparent supporter A was changed to the transparent supporter M.

The obtained optical anisotroic layer M had a linearity of 44 μm per length of 622.3 mm.

[Production of a Patterned Phase Difference Plate N]

A patterned phase difference plate N was produced using the same method for the patterned phase difference plate A except for the fact that, in the production of the patterned phase difference plate G, the transparent supporter A was changed to the transparent supporter N.

The obtained optical anisotroic layer N had a linearity of 66 μm per length of 1134 mm.

(Production of a Stereoscopic Image Liquid Crystal Display Device A)

The patterned phase difference plate was peeled from an stereoscopic image display device (32ZP2 manufactured by Toshiba). Furthermore, instead of the patterned phase difference plate, the patterned phase difference plate A was attached onto a front polarization plate through an adhesive, thereby producing a stereoscopic image liquid crystal display device A. Meanwhile, the patterned phase difference layer was attached so as to be located on the front polarization plate side.

(Production of a Stereoscopic Image Liquid Crystal Display Device B)

A stereoscopic image liquid crystal display device B was produced using the same method as for the production of the stereoscopic image liquid crystal display device A except for the fact that, in the production of the stereoscopic image liquid crystal display device A, the patterned phase difference plate B was used instead of the patterned phase difference plate A.

(Production of a Stereoscopic Image Liquid Crystal Display Device C)

A stereoscopic image liquid crystal display device C was produced using the same method as for the production of the stereoscopic image liquid crystal display device A except for the fact that, in the production of the stereoscopic image liquid crystal display device A, the patterned phase difference plate C was used instead of the patterned phase difference plate A.

(Production of a Stereoscopic Image Liquid Crystal Display Device D)

The patterned phase difference plate was peeled from an stereoscopic image display device (55LW5700 manufactured by LG Electronics). Furthermore, instead of the patterned phase difference plate, the patterned phase difference plate D was attached onto a front polarization plate through an adhesive, thereby producing a stereoscopic image liquid crystal display device D. Meanwhile, the patterned phase difference layer was attached so as to be located on the front polarization plate side.

(Production of a Stereoscopic Image Liquid Crystal Display Device E)

A stereoscopic image liquid crystal display device E was produced using the same method as for the production of the stereoscopic image liquid crystal display device D except for the fact that, in the production of the stereoscopic image liquid crystal display device D, the patterned phase difference plate E was used instead of the patterned phase difference plate D.

(Production of a Stereoscopic Image Liquid Crystal Display Device F)

A stereoscopic image liquid crystal display device F was produced using the same method as for the production of the stereoscopic image liquid crystal display device D except for the fact that, in the production of the stereoscopic image liquid crystal display device D, the patterned phase difference plate F was used instead of the patterned phase difference plate D.

(Production of a Stereoscopic Image Liquid Crystal Display Device G)

A stereoscopic image liquid crystal display device G was produced using the same method as for the production of the stereoscopic image liquid crystal display device A except for the fact that, in the production of the stereoscopic image liquid crystal display device A, the patterned phase difference plate G was used instead of the patterned phase difference plate E.

(Production of a Stereoscopic Image Liquid Crystal Display Device H)

A stereoscopic image liquid crystal display device H was produced using the same method as for the production of the stereoscopic image liquid crystal display device A except for the fact that, in the production of the stereoscopic image liquid crystal display device A, the patterned phase difference plate H was used instead of the patterned phase difference plate A.

(Production of a Stereoscopic Image Liquid Crystal Display Device I)

A stereoscopic image liquid crystal display device I was produced using the same method as for the production of the stereoscopic image liquid crystal display device A except for the fact that, in the production of the stereoscopic image liquid crystal display device A, the patterned phase difference plate I was used instead of the patterned phase difference plate A.

(Production of a Stereoscopic Image Liquid Crystal Display Device J)

A stereoscopic image liquid crystal display device J was produced using the same method as for the production of the stereoscopic image liquid crystal display device D except for the fact that, in the production of the stereoscopic image liquid crystal display device D, the patterned phase difference plate J was used instead of the patterned phase difference plate D.

(Production of a Stereoscopic Image Liquid Crystal Display Device K)

A stereoscopic image liquid crystal display device K was produced using the same method as for the production of the stereoscopic image liquid crystal display device D except for the fact that, in the production of the stereoscopic image liquid crystal display device D, the patterned phase difference plate K was used instead of the patterned phase difference plate D.

(Production of a Stereoscopic Image Liquid Crystal Display Device L)

A stereoscopic image liquid crystal display device L was produced using the same method as for the production of the stereoscopic image liquid crystal display device D except for the fact that, in the production of the stereoscopic image liquid crystal display device D, the patterned phase difference plate L was used instead of the patterned phase difference plate D.

(Production of a Stereoscopic Image Liquid Crystal Display Device M)

A stereoscopic image liquid crystal display device M was produced using the same method as for the production of the stereoscopic image liquid crystal display device A except for the fact that, in the production of the stereoscopic image liquid crystal display device A, the patterned phase difference plate M was used instead of the patterned phase difference plate A.

(Production of a Stereoscopic Image Liquid Crystal Display Device N)

A stereoscopic image liquid crystal display device N was produced using the same method as for the production of the stereoscopic image liquid crystal display device D except for the fact that, in the production of the stereoscopic image liquid crystal display device D, the patterned phase difference plate N was used instead of the patterned phase difference plate D.

(Production of a Stereoscopic Image Liquid Crystal Display Device O)

A 32ZP2 manufactured by Toshiba was used as a stereoscopic image liquid crystal display device O. The optical anisotropic layer formed on the patterned phase difference plate peeled from the 32ZP2 manufactured by Toshiba had a linearity of 49 μm per length of 622.3 mm.

(Production of a Stereoscopic Image Liquid Crystal Display Device P)

A 55LW5700 manufactured by LG Electronics was used as a stereoscopic image liquid crystal display device P. The optical anisotropic layer formed on the patterned phase difference plate peeled from the 55LW5700 manufactured by LG Electronics had a linearity of 78 μm per length of 1134 mm.

<Evaluation>

(1) Vertical-Direction Crosstalk View Angle

In a dark room, 3D glasses accompanied by 55LW5700 (manufactured by LG Electronics) and a measurement device (BM-5A manufactured by Topcon Corporation) were disposed on the front surface of the liquid crystal display device displaying a striped image in which black stripes and white stripes were alternately arrayed in the vertical direction. The measurement device was placed at a location aligned with a side of the 3D glasses on which white stripes were viewable, and the front surface brightness C was measured. Subsequently, a striped image in which the locations of white and black were switched was displayed, the front surface brightness D was measured in the same manner using the same side of the glasses as previous, and the front surface crosstalk was computed using the following formula.

Front surface crosstalk=front surface brightness D/front surface brightness C×100%

Subsequently, the front surface crosstalk was measured at nine intersection points determined by dividing a display section of the liquid crystal display device into four equal parts in the horizontal direction and in the vertical direction respectively, and the average value was computed as the average front surface crosstalk.

In addition, at the nine points at which the front surface crosstalk was measured, a measurement device was inclined against the liquid crystal display device in the vertical direction while holding the positional relationship between 3D glasses and the measurement device, the brightness was measured based on the same striped image as the front surface crosstalk, and the crosstalk in the vertical direction was measured using the same considering method. A view angle range in which all the measurement points were within 5% or less from the average front surface crosstalk was defined as the crosstalk view angle in the vertical direction based on the obtained crosstalk, and was computed.

(2) 3D Boundary Variation

A striped image on which white and black stripes were alternately arrayed in the vertical direction was displayed on a liquid crystal display device, 3D glasses mounted in a 55LW5700 manufactured by LG Electronics were worn, light was shielded at a glass lens through which the white stripes were visible on the front surface, and the liquid crystal display device was observed from the front surface and the vertical direction at a distance that was three times the length of the image in the vertical direction. As a result, while the entire screen displayed black on the front surface; however, when the inspection angle in the vertical direction was increased, the brightness leakage was observed in a region having a large view angle. Here, 3D boundary variation observed at the boundary between a black display region and the brightness leakage region was observed. In the evaluation, the black display part in the display surface means that there is no or little crosstalk, and the brightness leakage-observable region and the white display part means that there is crosstalk. It means that, when the linearity of the 3D boundary variation is poor, the crosstalk variation in the screen during 3D display is great, and consequently, the stereoscopic effect of a 3D image is impaired. The 3D boundary variation in the vertical direction was evaluated based on the following criteria using a stereoscopic image display device having no 3D boundary variation observed on the front surface.

A: the meandering of the 3D boundary variation is not observed.

B: the meandering of the 3D boundary variation is slightly observed, which is acceptable in terms of 3D quality.

C: the 3D boundary variation is clearly observed, which is not acceptable in terms of 3D quality.

TABLE 1

| | | | Linearity of supporter used to manufacture FPR film | | | | | |
|---|---|---|---|---|---|---|---|---|
| | | | (linearity of patterned phase difference layer) | | | | | |
| | | | | | | Linearity of | Crosstalk | |
| | Stereoscopic | | | 1209 mm | | optical | view angle in | |
| | image display | | 697.3 mm | (for 55-inch | Linearity of | anisotropic | vertical | 3D boundary |
| | device | Supporter | (for 32-inch use) | use) | supporter | layer | direction | variation |
| Example 1 | A | A | 74 μm (25 μm) | — | O (0.0189%) | O (0.0064%) | 13.4 | B |
| Comparative | B | B | 92 μm (44 μm) | — | X (0.0235%) | X (0.0112%) | 12.0 | C |
| Example 1 | | | | | | | | |
| Example 2 | C | C | 32 μm (9 μm) | — | O (0.0082%) | O (0.0023%) | 15.2 | A |
| Example 5 | G | G | 73 μm (19 μm) | — | O (0.0186%) | O (0.0048%) | 13.3 | B |
| Comparative | H | H | 116 μm (51 μm) | — | X (0.0296%) | X (0.0130%) | 11.6 | C |
| Example 3 | | | | | | | | |
| Example 6 | I | I | 43 μm (10 μm) | — | O (0.0110%) | O (0.0025%) | 15.1 | A |
| Comparative | M | M | 91 μm (44 μm) | — | X (0.0232%) | X (0.0112%) | 12.0 | C |
| Example 5 | | | | | | | | |
| Comparative | O | — | −(49 μm) | — | — | X (0.0125%) | 11.7 | C |
| Example 6 | | | | | | | | |

TABLE 2

| | | | Linearity of supporter used to manufacture FPR film | | | | | |
|---|---|---|---|---|---|---|---|---|
| | | | (linearity of patterned phase difference layer) | | | | | |
| | | | | | | Linearity of | Crosstalk | |
| | Stereoscopic | | | | | optical | view angle in | |
| | image display | | 697.3 mm | 1209 mm | Linearity of | anisotropic | vertical | 3D boundary |
| | device | Supporter | (for 32-inch use) | (for 55-inch use) | supporter | layer | direction | variation |
| Example 3 | D | D | — | 126 μm (42 μm) | O (0.0185%) | O (0.0062%) | 23.1 | B |
| Comparative | E | E | — | 165 μm (66 μm) | X (0.0243%) | X (0.0097%) | 21.4 | C |
| Example 2 | | | | | | | | |
| Example 4 | F | F | — | 74 μm (17 μm) | O (0.0109%) | O (0.0025%) | 25.0 | A |
| Example 7 | J | J | — | 131 μm (44 μm) | O (0.0193%) | O (0.0065%) | 23.0 | B |
| Comparative | K | K | — | 179 μm (74 μm) | X (0.0263%) | X (0.0109%) | 21.2 | C |
| Example 4 | | | | | | | | |
| Example 8 | L | L | — | 49 μm (10 μm) | O (0.0072%) | O (0.0015%) | 25.1 | A |
| Comparative | N | N | — | 163 μm (66 μm) | X (0.0240%) | X (0.0097%) | 21.4 | C |
| Example 7 | | | | | | | | |
| Comparative | P | — | — | −(78 μm) | — | X (0.0115%) | 20.8 | C |
| Example 8 | | | | | | | | |

From the tables, it is found that, in the examples in which the linearity of the edge in a direction along the pattern of the supporter is 0.0195% or less of the length in a direction perpendicular to the direction along the pattern of the image display panel, not only the crosstalk in the vertical direction but also the 3D boundary variation are improved. In addition, it is also found that the optical anisotropic layer also has a high linearity in accordance with the linearity at the edge of the supporter.

On the other hand, it is found that, in the comparative examples in which the length of a line perpendicular to a straight line in parallel with the lateral direction of the stereoscopic image display device, which combines both edge of the supporter in the patterned optical anisotropic layer in the longitudinal direction fails to satisfy the requirement of being 0.0195% or less of the length in the lateral direction of the stereoscopic image display device, the 3D boundary variation is poor compared with the examples, and therefore both the crosstalk in the vertical direction and the 3D boundary variation are not improved.

In Examples 1 to 8, a cellulose acylate-based film having a film thickness of 80 μm is used, but the same effects can be obtained even when a cellulose acylate-based film having a film thickness of 60 μm, 40 μm, or 30 μm is used.

In addition, in the patterned phase difference plates used in Examples 1 to 8, the patterned optical anisotropic layers made of the perpendicularly-oriented discotic liquid crystal were formed, but the same effects could be obtained even in a patterned phase difference plate in which a patterned optical anisotropic layer made of a horizontally-oriented rod-shaped liquid crystal was formed, which was produced using the same method except for the fact that a photo-oriented film-attached transparent supporter having the following composition was used instead of the rubbing oriented film-attached transparent supporter and an optical anisotropic layer having the following composition was used instead of the patterned optical anisotropic layer made of the vertically-oriented discotic liquid crystal.

<Production of the Photo-Oriented Film-Attached Transparent Supporter>

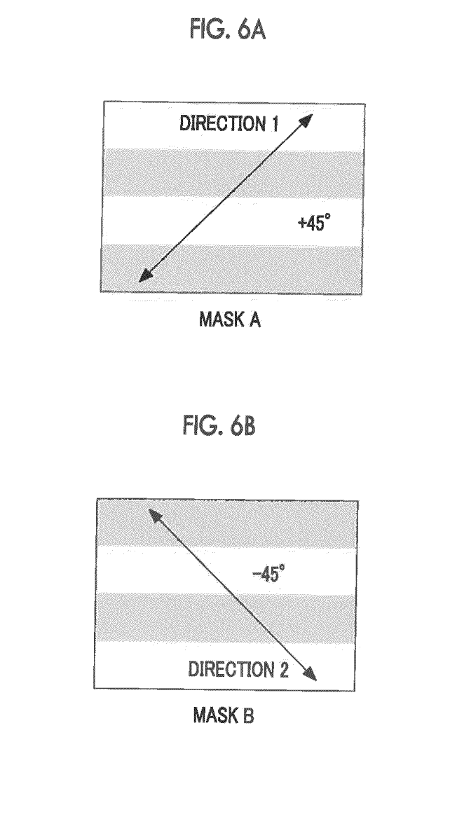

A 1% aqueous solution of a photo-oriented material E-1 having the following structure was applied to a surface on which the saponification treatment of the supporter had been carried out, and was dried for one minute at 100° C. An ultraviolet ray was radiated on the obtained coated film using a 160 W/cm² air-cooling metal halide lamp (manufactured by Eye Graphics Co., Ltd.) in the air. At this time, a wire grid polarizer (manufactured by Moxtek Incorporated, ProFlux PPL02) was set in a direction 1 as illustrated in FIG. 6A, and furthermore, exposure was conducted through a mask A (a stripe mask having the same horizontal stripe width in the transmission portion and in the shield portion). After that, the wire grid polarizer was set in a direction 2 as illustrated in FIG. 6B, and furthermore, exposure was conducted through a mask B (a stripe mask having the same horizontal stripe width in the transmission portion and in the shield portion). The distance between the exposure mask surface and the photo-oriented film was set to 200 μm. At this time, the illuminance of the ultraviolet ray was set to 100 mW/cm² in a UV-A region (integration of a wavelength in a range of 380 nm to 320 nm), and the radiation amount was set to 1000 mJ/cm² in the UV-A region.

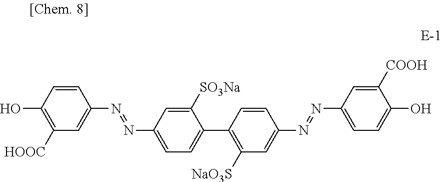

<Production of the Patterned Optical Isotropic Layer>

After the preparation of the following composition for the optical anisotropic layer, the composition was filtered using a polypropylene filter having a pore diameter of 0.2 μm, and was used as a coating solution. The coating solution was applied onto the photo-oriented film-attached transparent supporter, was dried at a film surface temperature of 105° C. for two minutes so as to form a liquid crystal state, then, was cooled to 75° C., and the orientation state was solidified by radiating an ultraviolet ray using a 160 W/cm² air-cooling metal halide lamp (manufactured by Eye Graphics Co., Ltd.) in the air, thereby trying to produce a patterned optical anisotropic layer on the transparent supporter. The film thickness of the optical anisotropic layer was 1.3 μm.

The composition for the optical anisotropic layer

| | |
|---|---|
| Rod-shaped liquid crystal (LC242, manufactured by | 100 parts by mass |
| BASF Japan Ltd.) | |
| Horizontal orientation agent A | 0.3 parts by mass |
| Photopolymerization initiator | 3.3 parts by mass |
| (IRGACURE907 manufactured by Ciba | |
| Specialty Chemicals Inc.) | |
| Sensitizer (KAYACURE DETX, manufactured by | 1.1 parts by mass |
| Nippon Kayaku Co., Ltd.) | |
| Methyl ethyl ketone | 300 parts by mass |

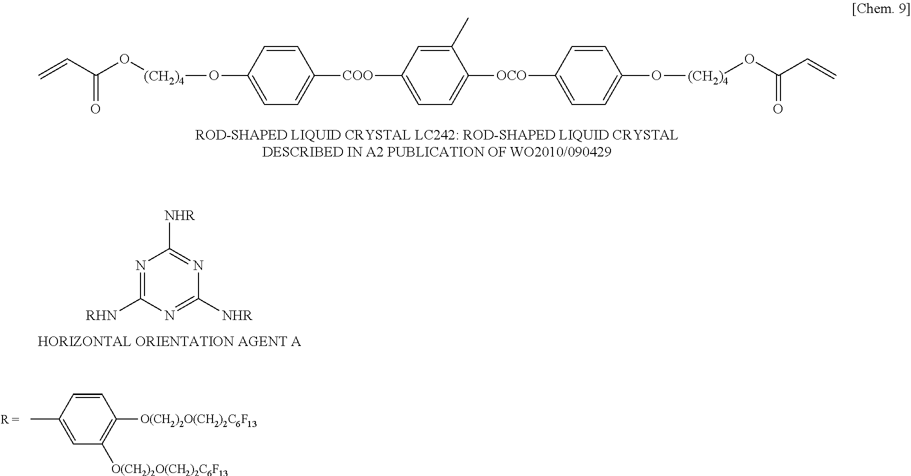

The same effects can be obtained using a cellulose acylate-based film produced using a different production method and a different material instead of the cellulose acylate-based films used in Examples 1 to 8. For example, in Examples 3, 4, 7, and 8, Comparative Examples 2 and 4, the same effects could be obtained even when the transparent supporter R was used instead of the transparent supporter D, the transparent supporter T was used instead of the transparent supporter F, the transparent supporter U was used instead of the transparent supporter J, the transparent supporter W was used instead of the transparent supporter L, the transparent supporter S was used instead of the transparent supporter E, and the surface film V was used instead of the surface film K.

In addition, the same effects could be obtained using a transparent supporter having a film thickness of 100 μm produced using the same method as in Example 2 of JP4962661B, a transparent supporter having a film thickness of 40 μm produced using the same method as in Example 4 of JP2010-270162A, a commercially available norbornene-based polymer film “ZEONOR ZF14-060” having a film thickness of 60 μm (manufactured by OPTES Inc.), a transparent supporter having a film thickness of 84 μm produced using the same method as for a protective film on which a low-moisture permeable layer was coated in Example 9 of JP2008-268938A, or a transparent supporter X having a film thickness of 50 μm on which a low-moisture permeable layer produced as described below was coated instead of the cellulose acylate-based film. That is, it is found that, when the linearity at the edge in a direction along the pattern of the supporter is 0.0195% or less of the length in a direction perpendicular to the direction along the pattern of the image display panel, it is possible to improve the visibility of the stereoscopic image display device regardless of the type of the supporter.

<Production of a Transparent Supporter X>

(Preparation of a Composition for Forming a Low Moisture Permeable Layer)

Individual components were mixed as described in the following table, then, the mixture was put into a glass separable flask equipped with a stirring device, was stirred at room temperature for five hours, and then was filtered using a polypropylene depth filter having a pore diameter of 5 μm, thereby obtaining a composition. Meanwhile, in the following table, the addition amounts of the respective components are expressed using “% by mass”.

TABLE 3

| | Solid content (resin) | | Solvent | | | | |
|---|---|---|---|---|---|---|---|
| | | Addition | | Addition | | Addition | Solid content |
| | Type | amount | Type | amount | Type | amount | concentration/% |
| A-1 | APEL APL5014DP | 100 | Cyclohexanone | 90 | Cyclohexanone | 10 | 15 |

Hereinafter, the used compounds will be described.
APEL APL5014DP: cyclic polyolefin resin (manufactured by Mitsui Chemicals, Inc.)

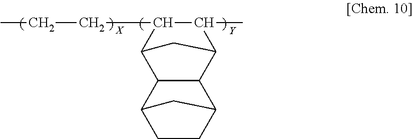

After the composition for forming a low moisture permeable layer A-1 was applied to the transparent supporter R using a gravure coater, the composition was dried at 25° C. for one minute, and subsequently, was dried at 80° C. for approximately five minutes, thereby producing a transparent supporter X having a film thickness of 50 μm on which a low moisture permeable layer having a film thickness of 10 μm was provided.

The moisture permeability (the moisture permeability at 40° C. and a relative humidity of 90%) of the produced transparent supporter X was measured. The moisture permeability of the transparent supporter X was 21 g/m²/day.

<Moisture Permeability (the Moisture Permeability at 40° C. And a Relative Humidity of 90%)>

As a method for measuring the moisture permeability, the method described in ‘the measurement of the vapor permeation amount (the mass method, the thermometer method, the vapor pressure method, and the adsorption amount method)’ on pages 285 to 294 of “the properties of macromolecules II” (the lectures on the experiments of macromolecules 4, Kyoritsu Shuppan Co., Ltd.) was applied.

The humidity of a specimen having 70 mmφ was adjusted at 40° C. and a relative humidity of 90% for 24 hours, and the moisture amount per unit area (g/m²) was computed using a moisture permeation cup and a formula: moisture permeability=mass after humidity adjustment-mass before humidity adjustment according to the method of JIS Z-0208. Meanwhile, in the present measurement, the mass change was measured under the above-described conditions using a blank cup containing no moisture absorbent, and the correction of the moisture permeability value was carried out.

In addition, even when a transparent supporter Y having a film thickness of 40 μm produced as described below was used instead of a cellulose acylate-based film, the same effects could be obtained. That is, it is found that, when the linearity at the edge in a direction along the pattern of the supporter is 0.0195% or less of the length in a direction perpendicular to the direction along the pattern of the image display panel, it is possible to improve the visibility of the stereoscopic image display device regardless of the type of the supporter.

<Production of the Transparent Supporter Y>

(Preparation of a Dope)

The following composition was injected into a mixing tank, and stirred under heating so as to dissolve individual components, thereby preparing a dope.

(Composition of the Dope)

| | |
|---|---|
| Cellulose acetate propionate | 30 parts by mass |
| DIANAL BR88 (product name), manufactured by | 70 parts by mass |
| Mitsubishi Rayon Co., Ltd., | |
| weight-average molecular weight of 1500000 | |
| (the cellulose ester and the acryl resin accounted for | |
| a total of 100 parts by mass) | |
| Moisture permeability-reducing compound A-5 | 50 parts by mass |
| Ultraviolet absorber (TINUVIN 328 manufactured | 2 parts by mass |
| by BASF Japan Ltd.) | |
| Dichloro methane | 447 parts by mass |
| Ethanol | 61 parts by mass |

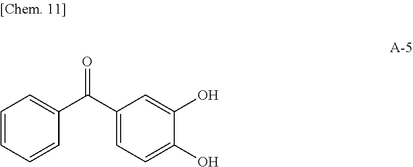 [SMILES: O=C(c1ccccc1)c1ccc(O)c(O)c1]

The solid content concentration (the total concentration of the cellulose ester, the acrylic resin, the moisture permeability-reducing compound, and the ultraviolet absorber) of the dope was 18% by mass.

The prepared dope was uniformly cast from a casting die to a 2000 mm-wide stainless steel endless band (casting supporter) using a band casting apparatus. The dope was peeled from the casting supporter as a macromolecular film when the amount of the residual solvent in the dope reached 40% by mass, was transported without being actively stretched using a tenter, and was dried in a drying zone at 130° C., thereby obtaining the transparent supporter Y having a film thickness of 40 μm.

The moisture permeability (the moisture permeability at 40° C. and a relative humidity of 90%) of the produced transparent supporter Y was 40 g/m²/day.

What is claimed is:

1. A stereoscopic image display device comprising at least:
an image display panel; and
a patterned phase difference plate disposed on an image-displaying side of the image display panel,
wherein the patterned phase difference plate includes at least a supporter and a patterned optical anisotropic layer having, on the supporter, first phase difference regions and second phase difference regions which are different in either or both an in-plane slow axis direction and a phase difference and are alternately disposed in a stripe shape, and
wherein, in edges of the supporter, a linearity, which is a meandering width in a direction perpendicular to a direction along the pattern of the patterned optical anisotropic layer, of an edge in a direction along a pattern of the patterned optical anisotropic layer is 0.0195% or less of a length in the direction perpendicular to the direction along the pattern of the patterned optical anisotropic layer in the image display panel.

2. The stereoscopic image display device according to claim 1 comprising:
a surface layer on a surface opposite to a surface on which the patterned optical anisotropic layer of the supporter is formed.

3. The stereoscopic image display device according to claim 1,
wherein the linearity in the direction along the pattern of the patterned optical anisotropic layer is 0.0065% or less of the length in the direction perpendicular to the direction along the pattern of the image display panel.

4. The stereoscopic image display device according to claim 2,
wherein the linearity in the direction along the pattern of the patterned optical anisotropic layer is 0.0065% or less of the length in the direction perpendicular to the direction along the pattern of the image display panel.

5. The stereoscopic image display device according to claim 1,
wherein the supporter is any one of a cellulose acylate-based film, a polyester-based film, an acryl-based film, and a norbornene-based film.

6. The stereoscopic image display device according to claim 2,
wherein the supporter is any one of a cellulose acylate-based film, a polyester-based film, an acryl-based film, and a norbornene-based film.

7. The stereoscopic image display device according to claim 3,
wherein the supporter is any one of a cellulose acylate-based film, a polyester-based film, an acryl-based film, and a norbornene-based film.

8. The stereoscopic image display device according to claim 4,
wherein the supporter is any one of a cellulose acylate-based film, a polyester-based film, an acryl-based film, and a norbornene-based film.

9. The stereoscopic image display device according to claim 1,
wherein the first and second phase difference regions have mutually orthogonal in-plane slow axes and have an in-plane retardation of λ/4.

10. The stereoscopic image display device according to claim 2,
wherein the first and second phase difference regions have mutually orthogonal in-plane slow axes and have an in-plane retardation of λ/4.

11. The stereoscopic image display device according to claim 3,
wherein the first and second phase difference regions have mutually orthogonal in-plane slow axes and have an in-plane retardation of λ/4.

12. The stereoscopic image display device according to claim 4,
wherein the first and second phase difference regions have mutually orthogonal in-plane slow axes and have an in-plane retardation of λ/4.

13. The stereoscopic image display device according to claim 5,
wherein the first and second phase difference regions have mutually orthogonal in-plane slow axes and have an in-plane retardation of λ/4.

14. The stereoscopic image display device according to claim 6,
wherein the first and second phase difference regions have mutually orthogonal in-plane slow axes and have an in-plane retardation of λ/4.

15. The stereoscopic image display device according to claim 1,
wherein a size of the image display panel is in a range of 32 inches to 65 inches.

16. The stereoscopic image display device according to claim 1,
wherein the image display panel is a liquid crystal display panel.

17. A method for manufacturing the stereoscopic image display device according to claim 1 including at least an image display panel and a patterned phase difference plate disposed on an image-displaying side of the image display panel,
wherein the patterned phase difference plate includes at least a supporter and a patterned optical anisotropic layer having, on the supporter, first phase difference regions and second phase difference regions which are different in either or both an in-plane slow axis direction and a phase difference and are alternately disposed in a stripe shape, and
wherein the patterned optical anisotropic layer is provided after, in edges of the supporter, a linearity, which is a meandering width in a direction perpendicular to a direction along the pattern of the patterned optical anisotropic layer, of an edge in a direction along a pattern of the patterned optical anisotropic layer is 0.0195% or less of a length in the direction perpendicular to the direction along the pattern of the patterned optical anisotropic layer in the image display panel.

18. A method for reducing boundary variation in the stereoscopic image display device according to claim 1 which includes at least an image display panel and a patterned phase difference plate disposed on an image-displaying side of the image display panel, and in which the patterned phase difference plate includes at least a supporter and a patterned optical anisotropic layer having, on the supporter, first phase difference regions and second phase difference regions which are different in either or both an in-plane slow axis direction and a phase difference and are alternately disposed in a stripe shape,
wherein, as the supporter, a supporter having a linearity, which is a meandering width in a direction perpendicular to a direction along a pattern of the patterned optical anisotropic layer, in an edge in the direction along the pattern of the patterned optical anisotropic layer of 0.0195% or less of a length in the direction perpendicular to the direction along the pattern of the patterned optical anisotropic layer in the image display panel is used.

19. A stereoscopic image display system comprising at least:
the stereoscopic image display device according to claim 1; and
a polarization plate disposed on an image-displaying side of the stereoscopic image display device,
wherein a stereoscopic image is displayed through the polarization plate.

20. A patterned phase difference plate used for the stereoscopic image display device according to claim 1, the patterned phase difference plate comprising at least:
a supporter; and
a patterned optical anisotropic layer having, on the supporter, first phase difference regions and second phase difference regions which are different in either or both an in-plane slow axis direction and a phase difference and are alternately disposed in a stripe shape,
wherein, in the supporter, a linearity, which is a meandering width in a direction perpendicular to a direction along the pattern of the patterned optical anisotropic layer, of an edge in a direction along a pattern of the patterned optical anisotropic layer is 0.0195% or less of a length in the direction perpendicular to the direction along the pattern of the patterned optical anisotropic layer.
